(19) United States
(12) Patent Application Publication
(10) Pub. No.: US 2003/0152510 A1
(43) Pub. Date: Aug. 14, 2003

(54) TS-PQ titano-silicate molecular sieves and methods for synthesis and use thereof

(76) Inventors: Ernest Senderov, Jamesburg, NJ (US); Richard J. Hinchey, Blue Bell, PA (US); Istvan Halasz, Collegeville, PA (US)

Correspondence Address: ROBERT S. LIPTON, ESQUIRE, 201 NORTH JACKSON STREET, P. O. BOX 934, MEDIA, PA, 19063-0934, US

(21) Appl. No.: 10/295,776

(22) Filed: Nov. 15, 2002

Related U.S. Application Data
(60) Provisional application No. 60/335,417, filed on Nov. 15, 2001.
(60) Provisional application No. 60/387,945, filed on Jun. 12, 2002.

(51) Int. Cl. C01B 33/20

(52) U.S. Cl. 423/713

(57) ABSTRACT

The present invention is directed towards methods for the cost-effective commercial manufacture of small crystal titanium-silicate molecular sieve products, toward a novel titano-silicate molecular sieve composition synthesized thereby, which the present inventors have termed “TS-PQ”, and toward uses of that molecular sieve composition as an oxidation catalyst.

### RELATED APPLICATIONS

The present application is a continuation-in-part of U.S. Application Ser. No. 60/335,417, filed Nov. 15, 2001, entitled “Methods for Preparing Titanium-Silicate Molecular Sieves” and U.S. Application Ser. No. 60/387,945, filed Jun. 12, 2002, entitled “TS-PQ Titano-Silicate Molecular Sieves and Methods For Synthesis and Use Thereof.”

### FIELD OF THE INVENTION

The present invention relates to methods for preparing TS-PQ titano-silicate molecular sieves, having the pentasil structure.

### BACKGROUND OF THE INVENTION

Crystalline titanium-silicate molecular sieves have titanium incorporated into the crystal lattice and are well known in the art. Examples of titanium-silicate molecular sieves are TS-1 with MFI-type structure and TS-2 with MEL-type structure, both of which are in the pentasil family of zeolite structures (Atlas of Zeolite Framework Types, Elsevier, 2001). Other examples are Ti-beta, Ti-ZSM48, Ti-ZSM12, Ti-MCM22, Ti-UTD1, and the like. These molecular sieves have been applied to catalytic oxidation of different organic substrates, for example, epoxidation of olefins, hydroxylation of aromatics, oxidation of cyclohexanol, and oxidation of alcohols, and exhibit excellent reactivity and selectivity in such catalytic oxidations. These crystalline titanium-silicates, when used as catalysts and/or catalyst supports, are useful in some industrial processes. TS-1 (see U.S. Pat. Nos. 4,410,501 and 4,666,692) and TS-2 (see Belgium Patent 1,001,038) molecular sieves, in particular, are synthetic, crystalline, medium-pore-microporous materials, which exhibit excellent catalytic reactivity and selectivity in various oxidation reactions. TS-1 and TS-2 are distinguished from their pure silica congeners by the substitution of small amounts of Ti for Si in the crystal lattice (the literature variously reports upper limits for Ti/(Si+Ti) mole ratios in Ti silicalites without non-framework admixture of from 0.01 to approximately 0.025[G. Deo et al., Zeolites 13 (1993) 365; L. Le Loc et al., Studies Surf Sci. Catal. 101 (1996) 611] to 0.025 [R. Millini et al., J. Catal. 137 (1992) 497] and even to 0.07 [A. Thangaraj et al., Zeolites 12 (1992) 943], although the higher ratio is in some doubt due to the purported presence of non-framework Ti in the samples. Superior catalytic properties are attributed to a combination of the catalytic oxidation properties of Ti sites and shape selectivity effects of the sieve framework. Compared with the traditional commercial processes, oxidation reactions catalyzed by titanium silicates, such as TS-1 and TS-2, have as one major advantage the minimization of the generation of environmentally unfriendly by-products having little or no commercial value. Such processes are thus known as “green” technologies. Use of Titano-silicate molecular sieves is not limited to reactions with H₂O₂ (aq) and other peroxide compounds, but also includes processes using O₂ as an oxidant. See Arends, I.W.C.E., et al. Oxidative Transformations of Organic Compounds Mediated by Redox Molecular Sieves, Angew. Chem. Inst. Ed. Engl. 1997, 36, 1144-1163.

The amount of Ti positioned within the framework of the molecular sieve is believed to be important and beneficial in many reactions. However, it is also widely believed that non-framework Ti-species, on the exterior or interior surfaces of crystals, may decrease the catalytic effectiveness of titanium-silicate molecular sieves. Similar deleterious effects may be caused by other contaminants such as aluminum and alkali elements. In particular, extraframework massive Ti-oxides, as well as other contaminants, cause undesirable side reactions, and, as a consequence, losses of activity and selectivity of the catalyst. Contaminants such as iron oxides may also promote the decomposition of H₂O₂, a reagent commonly used as an oxidant with such catalysts.

Contaminants in the synthesis gel composition also influence the degree to which titanium is incorporated into the crystal lattice. These considerations impose strict requirements for purity in synthesis raw materials and in procedures for preparation of titano-silicate molecular sieves to avoid the problems described above.

It is generally agreed in published technical and patent literature that catalysts based upon crystalline Ti-silicates should be free of massive Ti-oxides resulting from the agglomeration of non-framework Ti species. Many investigators have suggested that superior catalyst performance absolutely required that all Ti be present in tetrahedral coordination within the sieve lattice [B. Notari, Structure-Activity and Selectivity Relationships in Heterogeneous Catalysis (1991) 243]. More recent publications (e.g., U.S. Pat. No. 6,255,499), however, have introduced evidence that equivalent and even superior catalytic properties of titano-silicates may be associated with the presence of both tetrahedrally coordinated framework Ti and non-framework Ti in six-fold coordination, so long as such Ti species are not aggregated to form massive Ti-oxides. There can be also applications of Ti-catalyst where the presence of Ti-oxide is not detrimental, but even advantageous (U.S. Pat. No. 5,466,835). It is known from the technical literature that TS-1, synthesized by the original alkoxide method of U.S. Pat. No. 4,410,501 or its later modifications contains a diversity of Ti-sites (G. Deo et al.: ZEOLITES, 1993, Vol. 13, pp. 365-373; L. Le Loc et al., Studies Surf Sci. Catal. 101 (1996) 611; N. G.Gallegos et al.: CD Proceedings of 13^{th} IZC, Montpellier, France, 2001, 14-P-14). This new understanding of crystalline titano-silicate catalysts further emphasizes the importance of controlling the proportions of different kinds of Ti centers or Ti species by control of synthesis processes. The diversity of Ti centers in titano-silicates could not be revealed solely by XRD analysis and calculation of unit cell parameters of the product. In order to characterize different types of Ti incorporation depending on synthesis process, various techniques must be applied. X-ray diffraction is not sufficient, because the method is sensitive only to relatively large amounts of crystalline Ti-oxide admixture present in Ti silicate molecular sieve products and is not able to discriminate between subtle influences on unit cell parameters due to different types of Ti-incorporation. Not being bound by any specific theory we can speculate that between two extreme cases of: (a) isomorphous Ti incorporation into isolated tetrahedral framework sites and; (b) Ti admixture as massive Ti oxide phase outside molecular sieve crystals. There can be a number of intermediate situations, wherein, for example, Ti can be incorporated in a higher than four coordination state into the framework, or taken up as Ti oligomers within the crystal. In such cases there are not only isolated Ti atoms, but also Ti species forming Ti—O—Ti bonds inside or outside the framework, or residing as small amorphous oxide clusters dispersed in channels, or even as amorphous titano-silicate deposited on the surface of crystalline grains. Distinguishing, and controlling, different type of Ti centers must provide an important tool for the preparation of superior catalysts.

This control can be achieved by modified synthesis methods guided by improved analytical techniques. These improved techniques combine traditional techniques, directed toward determination of phase purity and crystallinity (XRD, adsorption measurements) and elemental analysis (XRF) to determine total Ti incorporation with various sensitive spectral methods, such as high resolution Fourier transform ultraviolet-visible diffuse reflectance in vacuum spectroscopy (FTUV-DRVS), Raman spectroscopy (RS), X-ray photoelectron spectroscopy (XPS) and others, which allow one to figure out distribution of total Ti between those centers.

Another significant factor influencing the working efficiency of a titanium-silicate molecular sieve is the size and morphology of the crystalline product. It is well known in the art that smaller particles and crystals allow more rapid diffusion through pores to catalytically active sites. The use of tetraethylorthosilicate (TEOS) as the silica source is widely practiced in the preparation of crystalline titano-silicates, not only because of the high purity of this reagent, but because the greater reactivity of this reagent results in a product with smaller (200-300 nanometer) crystals. However, TEOS is an expensive silica source that is both toxic and flammable. Hydrolysis of this compound generates an environmentally unfriendly alcohol by-product which must he eliminated from the reaction mixture before crystallization. In addition, the use of TEOS limits recycling of other reagents involved in the synthesis. Substitution of other less-costly silica or silica-titania materials directly into a conventional synthesis process based on TEOS does not result in the preferred small crystal product morphology.

For the reasons described above, methods of preparing titano-silicate molecular sieves as a high purity, fine crystalline product free of titanium-oxides and agglomerates would be desirable. In addition, the use of a lower cost, non-hazardous silica source, which allows recycling of synthesis liquors, has significant commercial value.

### SUMMARY OF THE INVENTION

The present invention is directed towards methods for the cost-effective commercial manufacture of small crystal titanium-silicate molecular sieve products, with variable combinations of different Ti centers, controlled by conditions of the process of preparation, and toward a novel titano-silicate molecular sieve composition synthesized thereby, which the present inventors have termed “TS-PQ™, because it is a titano-silicate material, discovered by them at PQ Corporation, of Valley Forge, Penn., USA. (The term TS-PQ™ is a trademark of PQ Corporation for its titano-silicate molecular sieve materials described herein.)

According to a first embodiment of the present invention, an inorganic silica source is reacted with an aqueous, alkaline solution of an organic structure directing agent (SDA), serving simultaneously as a source of a base and as a structure directing agent, under conditions sufficient to activate the silica source forming a colloidal, activated silica solution consisting of lower molecular weight silica species, which are more reactive than the silica source. This activated, colloidal silica solution is then combined with a titanium source under conditions sufficient to form titanium-silicate oligomeric species in a titanium-silicate solution. After a pretreatment step, consisting of a low temperature digestion, the titanium-silicate solution is crystallized at a higher temperature under autogenous pressure to form titanium-silicate crystals in a liquid phase. This two-stage process prior to crystallization at an elevated temperature is believed to be critical to the generation of large numbers of crystal nuclei of the Ti-silicate which, in turn, is a prerequisite to the preparation of high quality, small crystal Ti-silicate from low cost reagent sources of silica. Recovery of small crystals from suspension in their mother liquor is not a trivial task. The titanium-silicate crystals are separated from the liquid phase by various techniques, including the adjustment of the mother liquor pH by addition of an acid or acid salt to a range, where crystals are coagulated together with small amorphous titania-silica phase admixture. Product can also be recovered without amorphous contamination by centrifugation or by filtration using appropriate surface active agents as flocculants. The separated solids are then washed, dried and calcined to provide the titanium-silicate molecular sieve in a useful form.

According to a second embodiment of the present invention, the silica reagent is replaced by a silica-titania co-precipitated gel that is reacted with an alkaline solution of the organic SDA. This eliminates the steps of silica activation and combination with a titanium-containing reagent. The gel mixture produced by this procedure is again subjected to the pretreatment step prior to crystallization at elevated temperature and pressure.

According to a third embodiment of the present invention, a reactive silica source, a titanium source (or a titania-silica cogel instead of the reactive silica source and titanium source), and a Ti-complexing agent in aqueous solution are reacted under conditions sufficient to form titanium-silicate oligomeric species in a titanium-silicate solution. The reactive silica source may be the activated silica source prepared in the first embodiment or may be a tetraalkylorthosilicate. The Ti-complexing agent provides additional control of the rate of Ti availability in solution, thus promoting the distribution of titanium as a monomer combined with soluble silica species. After the pretreatment step to promote formation of small crystals, the titanium-silicate solution is crystallized to form a titanium-silicate molecular sieve containing a predominant proportion of Ti in tetrahedral positions. The titanium-silicate crystals are separated and processed as previously described.

According to a fourth embodiment of the present invention, a crystalline titanium silicate may be synthesized by any of the procedures described in previous embodiments, including the optional use of a Ti complexing agent, separated and washed free of synthesis mother liquors. This material, prior to calcination, is treated with an aqueous acid solution of mineral or organic acid to dissolve labile, hydrous, precipitates of extraneous oxides of Ti, Fe and Al that may have been deposited on the surfaces of the product crystals. The acid treated product is given a final water wash to displace the acid solution and ensure optimum purity in the product. This material is then dried and calcined to yield the final molecular sieve product free of deleterious contamination by extraneous metal oxides.

According to a fifth embodiment of the present invention, a crystalline titanium silicate may be synthesized by any of the procedures described in previous embodiments, including the optional use of a Ti complexing agent, separated and washed free of synthesis mother liquors. This material, is calcined with steaming, which is thought to mobilize and transform non-framework Ti into species, that are not harmful for some applications.

It is to be understood that both the foregoing general description and the following detailed description are exemplary, but not restrictive, of the invention.

### BRIEF DESCRIPTION OF THE FIGURES

FIG. 1 depicts FT UV-VIS DRV Spectra of TS-PQ (PTFE background) with different Ti centers, see “Example 3” and “Example 4”.

FIG. 2 depicts FT-UV DRV Spectra of TS-PQ at 25° C. in the presence of various reactants.

FIG. 3 depicts FT-UV DRV Spectra of material, similar to prior art TS-1 at 25° C. in the presence of various reactants.

FIG. 4 depicts the turnover rates (TOR) and H₂O₂ efficiencies for the selective oxidation of n-hexane over a catalyst comprising TS-PQ; TS-PQ: 55° C.; 0.6 mol n-hexane/g catalyst; no solvent TS-1 [U.S. Pat. No. 5,126,491]: 55° C.; 0.041 mol n-hex/g catal.; in Met-OH; TS-1 [D. R. C. Huybrechts, P. L. Buskens, P. A. Jacobs, J. Molec. Catal. 71, 129 (1992)]: 100° C.; 0.24 mol n-hex/g catal.; in acetone.

FIG. 5 depicts oxidation of n-hexane by 30% aqueous H₂O₂ at the test conditions 5, 9, 11, and 15.

FIG. 6 depicts FTUV spectra of TS-PQ titano-silicate molecular sieve after evacuation at 3×10⁻³ Pa at 25 and 400° C. Resolution 0.5 nm.

FIG. 7 depicts the FTUV DRV spectrum at 25° C. of degassed Ti-silicate sample from Example 1.

FIG. 8 depicts FTUV DRV-spectra of samples from Example 5. a. First half of slurry acidified and centrifuged. b. Second half of slurry centrifuged only.

FIG. 9 depicts FTUV DRV-spectrum of TS-PQ synthesized in 30 gallon autoclave (Example 6).

a. Product recovered by centrifugation. b. Product recovered by acid coagulation.

FIG. 10 depicts the FTUV-DRV spectrum of TSPQ samples synthesized at atmospheric pressure (Example 8).

FIG. 11 depicts TS-PQ having the MEL-type framework. a. Product recovered by acid coagulation; b. Acid treated coagulated product from a. (Example 9).

FIG. 12 depicts FTUV DRV spectra of TSPQ calcined in the presence of steam (Example 10).

FIG. 13 depicts the FTUV DRV spectra of TS-PQ synthesized from Gel 1 (Example 11). 1-1. Recovered by centrifugation. 1-2. Recovered by coagulation. (Table 2).

FIG. 14 depicts the FTUV-DRV spectra of TSPQ synthesized from Gel 2 (Example 11). 2-1. Recovered by centrifugation. 2-2. Recovered by coagulation. (Table 2)

### DETAILED DESCRIPTION OF THE INVENTION

The present invention is directed towards methods for commercial preparation of crystalline titano-silicate molecular sieves with physical and chemical properties optimized for catalytic oxidation processes. A first embodiment according to the present invention comprises the steps of:

a) reacting a relatively low cost, polymeric, silica source with an aqueous, alkaline solution of an organic structure directing agent, which serves at the same time as a source of a base, under conditions sufficient to partially depolymerize and to activate the silica source forming an activated silica solution consisting of lower molecular weight silica species;

b) combining the activated silica solution with a titanium source under conditions sufficient to form titanium-silicate oligomeric species in a titanium-silicate solution;

c) pretreating the titanium-silicate solution under conditions such that a large number of Ti-silicate crystal nuclei are generated in the titanium-silicate solution;

d) crystallizing the titanium-silicate solution under conditions of temperature, pressure and agitation that result in the production of preferably phase pure crystalline titanium-silicate product, without contamination by Ti-oxide phases, in a liquid phase;

e) separating the fine crystal titanium-silicate particles from the liquid phase;

f) washing the titanium-silicate crystals with, preferably, water;

g) drying the titanium-silicate crystals after step f); and

h) calcining the titanium-silicate crystals under conditions which preserve Ti incorporation in the lattice and are sufficient to eliminate organic species from the sieve pore system to provide an accessible titanium-silicate molecular sieve.

According to the first embodiment of the method of the present invention, the silica source can be preferably selected from the group consisting of silica gel, precipitated silica, silica sol, fumed silica and other forms of polymerized, preferably high purity, amorphous silica. Preferably, the silica source is one that has minimal contaminants, such as alumina, Al₂O₃, since aluminum competes more effectively than titanium for positions in the crystalline silica lattice or framework during synthesis and generates undesirable acidity. Similarly, sodium cations are known to promote formation of extraframework Ti-oxides, which in turn causes decomposition of the oxidant during catalytic reactions. A silica gel that has been washed well, such as a commercial polyolefin-catalyst support is one such primary source of low-contaminant silica starting material. The activation of a silica gel in an organic base solution according to the present invention results in a depolymerization of silica species and formation of liquid organic silicate solution. Another appropriate silica source can be a colloidal silica sol, such as Nyacol products 2034D1 or 820DI. In the case of silica sol, activation may not require heating.

Regardless of the silica source selected, it is preferable that the mole ratio of water (H₂O) to SiO₂ in the mixture after the activation step is about 3:1 to about 20:1, preferably about 4:1 to about 10:1, and most preferably about 5:1 to about 8:1, This low H₂O:SiO₂ mole ratio is an advantage of the present invention over other formulae known in the art, because it results in: (a) increased yield per unit volume of crystallizer and (b) higher OH⁻/H₂O in the mixture, favoring smaller crystals and shorter cycle times in the synthesis process.

The organic structure directing agent (SDA) may be any known directing agent for the specified molecular sieve structural type. The SDA is preferably selected from the group consisting of compounds containing quaternary alkylammonium cations. Hydroxides of those cations are preferable because, in addition to their SDA function, they provide a source of alkalinity. It is known in the art that many other base materials are effective in dissolving silica, but tetrapropylammonium hydroxide (TPAOH) and tetrabutylammonium hydroxide (TBAOH) are preferred in the methods of the present invention because they are bases which are not only hydrolyze and depolymerize silica, but direct the crystallization process towards formation of particularly desirable MFI-type and MEL-type, respectively, molecular sieve products. Those hydroxides are produced in low-alkali versions, for example, by SACHEM. Such reagents are preferred in the methods of the present invention. For example, when TPAOH, preferably at about 40% by weight, is selected as the SDA, the titano-silicate molecular sieve that is produced has the MFI-type framework. When TBAOH, preferably about 55% by weight, is selected as the SDA, the titano-silicate molecular sieve that is produced has the MEL-type framework. The range of constituents added or reacted together in step a) can vary over a wide range depending on the constituents used and the particular titano-silicate molecular sieve desired to be produced. For example, the mole ratio of TPAOH or TBAOH to SiO₂ may range from about 0.1:1 to about 0.3:1, preferably from about 0.12:1 to about 0.36:1, and most preferably about 0.2:1 to about 0.3:1.

TPAOH and TBAOH may be used in combination with each other. TPAOH and TBAOH may also be used in combination with TPA-halide and/or TBA-halide salts, up to about 50 mole percent addition, to enhance the concentration of quaternary amine cation. TPAOH and TBAOH may be used in combination with other organic bases, for instance, tetraethyl ammonium hydroxide (TEAOH) and amines, such as hexamethylenediamine (HMD) and ethylenediamine (EDA), to enhance alkaline properties of the solution or to replace up to about 50 mole percent of TPAOH or TBAOH. Other tetraalkylammonium and SDA compounds known in the art may be used when other Ti-silicate structural type molecular sieves are to be prepared.

The Ti source added in step b) may be any suitable source for providing titanium in molecular sieve materials. The Ti source is preferably a slowly-hydrolyzing titanium compound, whose rate of hydrolysis is low enough to avoid high local Ti concentrations, leading to formation of polymeric titania species and developing extraframework Ti-oxide phases. Low Ti concentrations favor formation of titania-silica oligomers, which participate in crystallization of a Ti-molecular sieve. However, the Ti-compound should not be so stable that it stays in solution during crystallization and, therefore, unincorporated to the framework. Among preferred organic titanates are, for example: tetraalkyltitanates (alkoxides); and TYZOR (DuPont) products: tetra-n-butyl, tetraisopropyl, and tetrakis (2-ethylhexyl) titanates. In the presence of alcohols, the extent of hydrolysis of these titanate compounds can be further retarded. This permits Ti-alkoxides to be used in alcohol solution. Among the preferred titanates are also titanium complexes, such as chelates: acetylacetonate titanate, ethyl acetoacetate titanate, trithanolamine titanate, and lactic acid titanate. Appropriate inorganic compounds are titanium fluoride and ammonium titanium hexafluoride. When the added Ti source is titanium butoxide (tetra-n-butyl titanate), it is preferred that the titanium butoxide be dissolved in about 2-5 times, more preferably about 3 times, the weight quantity of an alcohol, such as 2-propanol. The Ti source is added preferably to achieve a mole ratio of TiO:SiO₂ from about 0.001 to about 0.07, more preferably from about 0.01 to about 0.025.

For the methods of the present invention being described, each of the steps may be carried out with varying parameters and conditions. The parameters and conditions, which are disclosed, allow one of skill in the art to carry out the particular described method(s) and are not meant to imply that the particular described method(s) cannot be effectively or efficiently carried out using other parameters and conditions, in the present invention. The specific parameters and conditions chosen vary due to many factors contributing to their selection, such as the particular constituent or element being used (i.e., silica source, organic structure directing agent, Ti source, and complexing agent), the desired size of the titano-silicate crystals to be produced, the economic and time constraints of a user of these methods, the user's device or facility required to carry out these methods.

The reacting step, or step a), of the first embodiment, causes activation of the silica source, producing a TPA-silicate solution when TPAOH is used, and a TBA-silicate solution when TBAOH is used. There are no absolute limits as to the conditions of this step. The time and temperature should be sufficient to allow formation of TPA-silicate or TBA-silicate solution species. It is preferred that the reacting step include agitating the silica source in the organic alkaline solution at a temperature from about 25° C. to about 100° C., more preferably about 80° C., for a length of time from about 1 hour to about 24 hours, more preferably from about 3 hours to about 5 hours, most preferably about 3 hours. When particularly reactive silica reagents such as colloidal silica sol are used, the temperature range can be extended down to about room temperature or lower with the same values for preferred parameters. This process step can be conducted under conditions such that water is evaporated from the mixture to increase solids and OH⁻ concentration and batch yield for the synthesis. It is also preferred that the method further includes, after the reacting step, cooling the activated silica solution to about ambient or room temperature after the silica activation process.

Step b), in which the Ti-source is added to the alkaline organic liquid silicate of the first embodiment, preferably includes agitating the activated silica solution, which may contain crystal nuclei, and a Ti source to form titanium-silicate oligomer species which are the “building blocks” for nucleation and growth of titanium-silicate crystals. The titanium-silicate oligomeric species are formed in a titanium-silicate solution at about room temperature or below for a length of time from about 0.5 hours to about 20 hours, more preferably from about 3 hours to about 5 hours, and most preferably about 5 hours. This step is carried out at a temperature not exceeding room temperature in order to decrease the rate of hydrolysis of the titanium compound and to minimize the formation of polymerized Ti-species, thereby minimizing extraframework or massive Ti-oxides as impurity in the Ti-silicate product. It is for this reason that the activated silica solution is preferably cooled after step a), which has the effect of decreasing the rate of hydrolysis of the titanium compound.

For step c) of the first embodiment, it is preferred that this step includes agitating the titanium-silicate solution at a temperature from about ambient or room temperature, which may be about 25° C., to about the boiling point, preferably from about 50° C. to about 100° C. and more preferably from about 60° C. to about 80° C., for a length of time from about 1 hour to about 6 days, preferably from about 12 hours to about 3 days. Most preferably, the conditions of this step are 80° C. for about 1 day. This step is done to promote formation of large numbers of crystal nuclei leading to the production of smaller size crystals when the reaction mixture is heated to elevated temperatures to cause crystal growth.

In reference to the crystallization step, step d) of the first embodiment, it is preferred that this step be carried out at a temperature from about 80° C. to about 190° C., more preferably at a temperature that is greater than the temperature at which the pretreatment step is carried out, for a length of time from about 2 hours to about 7 days. Preferably, the crystallization step is carried out at a temperature of about 160° C.-180 C. for about 6 hours to 2 days. Crystallization at temperatures below 100° C. have been shown generally to produce lower crystallinity products even after more than 10 days crystallization time.

With regard to the separation step, or step e) of the first embodiment, it is well known in the art that various techniques may be used to separate fine crystalline solids, such as titanium-silicate crystals, from a liquid phase. In the first embodiment of the present invention, several techniques may be used to separate the titanium-silicate crystals from the liquid phase. In a first technique, the pH of the aqueous mother liquor is reduced to a range from about 2 to about 10, preferably from about 2.5 to about 8.5. This decrease in pH may cause, in some cases, the soluble silica in the mother liquor to coagulate into an amorphous silica precipitate. In one of the examples (fully described later in the present application,) the pH was adjusted to about 9.0 by about 10% nitric acid, and then, after about 20 minutes, readjusted to a pH of about 2.5. Elemental analysis of a typical liquid phase separated by centrifuging from the solid shows that the weight fraction of silica dissolved in the liquid phase constitutes several percent of the silica consumed in crystallization. The coagulation process can be accelerated by heating the product slurry. The resulting precipitate forms relatively large and easily filterable particles that apparently entrain or occlude the fine titanium-silicate crystals. This voluminous precipitate is easily filterable and can readily be washed as a filter cake using ordinary commercial or laboratory filtration techniques. Neutralization of the alkaline mother liquor to effect coagulation may be accomplished by a variety of acid materials, including mineral acids, such as sulfuric, nitric, and hydrochloric, or acid salts such as ammonium nitrate or ammonium sulfate. Preferable neutralizing agents are those that will generate water-soluble salts and will not generate volatile or noxious gases. In a preferred technique, separation of titanium-silicate crystals from the liquid phase by coagulation is carried out by dilution of the crystallization slurry with deionized water, followed by heating the slurry to about 80° C. before adjusting the pH to about 3.5 using about a 10% aqueous solution of nitric acid. It is well-known in the art that “liquid phase” is referred to as “mother liquor” prior to the addition of an acid.

In an alternative separation technique, separation of the crystals from the mother liquor may be carried out by flocculation of the crystalline particles. Flocculation agents and techniques are well-known in the art. Separation of titanium-silicate crystals from the mother liquor by flocculation is preferably carried out by a two-fold dilution of the crystallization slurry with deionized water, followed by addition of the flocculent with vigorous mixing.

Centrifugation is yet another separation technique.

The washing step of many of the methods of the present invention may be effected using various techniques known in the art for washing molecular sieve products. Washing the titanium-silicate crystals serves to ensure optimum purity in the crystal products by removing a substantial amount, and preferably all, of the impurities in the products. The washing step of many of the methods is preferably carried out by deionized water. The washing step, however, may also he carried out by alcohols, acids, or other known reagents known in the art.

The drying step of the methods of the present invention may be affected using various techniques known in the art for drying molecular sieve products. Drying the titanium-silicate crystals serves to remove a substantial amount, and preferably all, of the physically adsorbed water from the crystal products. If a substantial amount of water is retained in the solids, the presence of moisture at the high temperatures of calcination is likely to induce hydrolysis of titanium from the framework of the titanium-silicate crystals. In the drying step, drying of the titanium-silicate crystals may be carried out at a temperature from about 80° C. to about 170° C., preferably at about 120° C., for a time sufficient to remove substantially all of the water.

In reference to the calcining step in the procedures of the present invention, it will be recognized by one with skill in the art that various techniques may be used to calcine molecular sieve materials containing organic compounds. Any such techniques may be used in the methods of the present invention. For materials containing combustible organic compounds, care must be taken to prevent excessive temperature excursions due to heat generated by combustion. Excess heat can cause damage to the zeolite crystal structure or result in displacement of Ti from the crystal lattice. Damage can be prevented by control of the oxygen content in the calcination atmosphere, by dilution with a non-oxidizing gas, such as nitrogen, by reducing the feed rate to a continuous calciner, such as a rotary kiln, or by operating the calciner at the lowest effective temperatures. In a two-stage calcination much of the organic material is driven off at a lower temperature in a first stage without forming a flame and the remaining, pyrolyzed organic material is burned off in a second stage calcination at a higher temperature. Calcining the titanium-silicate crystals serves to eliminate organic species from the pores of the titanium-silicate crystals. Calcination of the titanium-silicate crystals may be carried out at a temperature from about 450° C. to about 650° C., preferably from about 500° C. to about 550° C., for a time sufficient to remove substantially all organic residues from the pore space of the sieve structure.

Dried samples of Ti-silicate can be characterized by TGA analysis to determine the quantity of organic material in the framework and to confirm the presence or absence of any amorphous admixture.

A calcined Ti-silicate molecular sieve characterized by X-ray diffraction (XRD) and by nitrogen adsorption (BET method) data, to confirm phase purity and product quality relative to known high quality reference materials. XRF analysis is used to determine the product elemental composition. High resolution FTUV-DRVS allows the identification of various types of Ti centers having characteristic absorption bands corresponding to coordination ranging from tetrahedral framework Ti to massive, octahedral Ti-oxide. The absence of Ti-oxide impurities is indicated also by Raman spectroscopy and XRD, and UV-VIS and XPS data can be used to show the simultaneous presence of tetrahedral and higher coordinated Ti. Crystal size is estimated by SEM and TEM examination. In addition, certain catalytic reactions may be carried out in the presence of the material, and reaction rates and reagent usage measured to characterize the performance of the material.

In a second embodiment of the present invention, instead of silica gel, a titania-silica cogel, such as is known in the industry as a polyolefin catalyst support, may be used. This allows elimination of the Ti addition step (b) and the combination of step (a) with step (c), while the parameters of step (c) and the subsequent steps may be the same as in the first embodiment.

A third embodiment of the present invention is a method for preparing a titanium-silicate molecular sieve comprising the steps of:

a) combining a reactive silica source and a titanium source together with a Ti complexing agent under conditions sufficient to form titanium-silicate oligomeric species in a titanium-silicate solution;

b) pretreating the titanium-silicate solution at a low temperature to promote nucleation of a large number of crystal nuclei;

c) crystallizing the titanium-silicate solution under conditions sufficient to produce titanium-silicate crystals in a liquid phase;

d) separating the titanium-silicate crystals from the liquid phase;

e) washing the titanium-silicate crystals with, preferably, water;

f) drying the titanium-silicate crystals; and

g) calcining the titanium-silicate crystals to provide the titanium-silicate molecular sieve.

For the third embodiment of the method of the present invention being described, the reactive silica source may be a tetraalkylorthosilicate (preferably tetraethylorthosilicate (TEOS)) or may be the result of step a) of the first embodiment. When TEOS is used, the silica activation step a) of the first embodiment is not required, because TEOS will generate monomeric silica species when it undergoes hydrolysis. However, when a form of condensed silica, such as silica gel, colloidal silica sol, or fumed silica is used, the silica is activated by reacting the silica with an aqueous solution of the organic structure directing agent in the manner described in the first embodiment.

The Ti-complexing agent is preferably an amine source selected from the group consisting of hexamethylenediamine (HMD), ethylenediamine (EDA), n-butylamine, diethylamine, diethanolamine, and triethanolamine. The preferred amine sources are HMD and EDA. It is preferred that the amine source be added in an amount sufficient to achieve a mole ratio of HMD or EDA to SiO₂ from about 0.1:1 to about 1:1, preferably from about 0.25:1 to about 0.5:1. Without being bound by any theory, it is believed that the amine source acts as a complexing agent, combining with Ti(OH)₄ released by hydrolysis of the Ti reagent. This restricts the instantaneous concentration of Ti(OH)₄ in solution inhibiting self condensation of Ti(OH)₄ and favoring the alternative copolymerization of Ti(OH)₄ with available silica oligomers. Thus, additional equilibrium controls are imposed on the reactivity of the titanium source promoting preferential interaction between the Ti monomer and silica species and further restricting the formation of massive titanium oxides. In general, any organic or inorganic ligand species, such as fluoride, that is capable of displacing OH⁻ from the Ti(IV) coordination sphere will be effective in inhibiting self-condensation of Ti(OH)₄. The titanium reagent source may preferably be selected from the group described above in the first embodiment and the procedure of the third embodiment may be used. In addition, all other process steps and parameters may be identical to those described above in connection with the first embodiment.

A titano-silicate molecular sieve product of the third embodiment is characterized by the predominance of tetrahedral Ti in the solid (FTUV-DRVS and XPS data).

A fourth embodiment of the method for preparing a titanium-silicate molecular sieve comprises the steps of:

a) combining a reactive silica source and a titanium source under conditions sufficient to form titanium-silicate oligomeric species in a titanium-silicate solution;

b) pretreating the titanium-silicate solution by aging at a low temperature to promote formation of a large number of crystal nuclei or nuclear precursors;

c) crystallizing the titanium-silicate solution under conditions sufficient to produce titanium silicate crystals in a liquid phase;

d) separating the titanium-silicate crystals from the liquid phase;

e) washing the titanium-silicate crystals singly or repeatedly with an aqueous solution (0.05-10%) of any strong acid, such as nitric, sulfuric, or hydrochloric, in order to leach Ti of higher coordination state preferentially from external surfaces of crystals followed by a final washing with deionized water;

f) drying the titanium-silicate crystals after step e); and

g) calcining the titanium-silicate crystals after step e) or g) to provide the titanium-silicate molecular sieve.

For the fourth embodiment of the method of the present invention being described, the steps are substantially similar to those described above for the third embodiment, except that the Ti-complexing agent need not, but may be, included in this third embodiment. Step a) of the first embodiment may also be used to prepare the reactive silica source, as in the second embodiment. The fourth embodiment differs, however, from the first and second embodiments in that an acid washing step is included after the recovering step and before the drying step.

The washing step of the fourth embodiment serves to remove extraframework Ti on the surface of the titanium-silicate crystals. The acidic wash treatment preferably includes washing the titanium-silicate crystals with an aqueous acidic solution. The aqueous acidic solution may comprise usually about a 0.1% aqueous nitric or hydrochloric acid solution or about a 0.05% aqueous sulfuric acid solution. Preferably, the acid wash is then followed by washing with deionized water. Small amounts of HF or NH₄F may be added to the acid wash solution to further facilitate the dissolution of Ti-oxides by forming soluble fluorotitanates. Such treatment may further improve the quality of the titano-silicate sieve of this invention by complexing and solubilizing other deleterious metal oxide impurities, such as Fe oxide, which are known to catalyze H₂O₂ decomposition. However, treatment with diluted acid solution may not be enough. All non-framework Ti is removed if dried filter-cake is treated with concentrated acid solution.

A titano-silicate molecular sieve product of the fourth embodiment is characterized by a decreased fraction or complete absence of non-framework Ti in the solid (UV-VIS and XPS data) as compared to the titano-silicate molecular sieve materials of the prior art.

Finally, in a fifth embodiment, the recovered material (after the recovering step) is calcined with steaming for a period of time sufficient to reduce the amount of undesirable non-framework Ti and other metal contaminants which may be present in the recovered material.

In sum, the methods of the present invention allow the use of a low cost, non-flammable and minimally contaminated silica source, namely silica gel, colloidal silica or precipitated silica, in the preparation of a titano-silicate molecular sieve having homogeneously distributed titanium in the crystal lattice. In addition, the crystal size of the product, which can be of the order of about 100-200 nm, may be controlled by the pretreatment step, among other factors. Furthermore, the optional usage of amine sources or other complexing agents may slow the hydrolysis of the titanium reagent compound, thereby minimizing the formation of extraframework titanium species. Moreover, extraframework titanium and significant amounts of other metal oxide impurities may be removed to a different extent, including complete removal, by the various intensity acid washing/acid treatment steps discussed in the fourth embodiment of the present invention. Such purification is especially effective when the acid washing is practiced in the presence of cation complexing agents known to combine with target metal contaminants. Moreover, formation of non-framework Ti can be to some extent prevented if recovering of product is conducted without substantial change of pH of the mother liquor solution.

The titano-silicate molecular sieves of the present invention are useful in the preparation of oxidation catalysts or catalyst supports having superior activity and selectivity. As is well-known, such catalysts may be made by combining the active molecular sieve, in calcined or un-calcined form, with a binder material that is preferably inactive, and forming the mixture either as beads or extrudate of varying dimensions. The formed product is subsequently calcined in a manner and under conditions appropriate to the particular binder system chosen. Such calcination procedures are well-known in the art which effectively “set” the binder to provide mechanical strength and durability to the matrix of the formed product. In some cases, the formed catalyst product may be prepared using uncalcined molecular sieve so that the final calcination to set the binder also serves to activate the titano-silicate sieve phase by simultaneously eliminating organic species from the lattice pores.

The TS-PQ titano-silicate molecular sieves of the present invention can show marked differences from the titano-silicate molecular sieves of the prior art, particularly TS-1. In particular, the following differences are seen:

These differences are explicitly revealed when TS-PQ titano-silicate molecular sieve is characterized on FT UV-VIS DRV spectra by its low absorption bands near ˜200-210 nm, which may be attributed to isolated Ti centers, and its dominant UV absorption around ˜220 nm (see examples 1 and 3 below). However, the method described above also allows preparation of TS-PQ with predominantly the 200-210 nm band with or without the 220 nm band. TS-PQ titano-silicate molecular sieve also may have absorption bands in the 240-300 nm and ˜330 nm UV region that are thought to be indicative of the presence of octahedrally coordinated Ti in an amorphous titano-silicate and the anatase phase, respectively. Dominant adsorption near 220 nm has not been reported for pentasil crystalline Ti-silicate type material.

Based on IR spectroscopy observations, TS-PQ titano-silicate molecular sieve contains more hydrogen bonded silanol (Si—OH) groups than free terminal or isolated internal silanol groups. The opposite has been reported for TS-1.

Evidence from evaluation of catalytic reactions further confirms that TS-PQ titano-silicate molecular sieve can be functionally distinct from titano-silicate molecular sieves of the prior art (such as TS-1). TS-PQ titano-silicate molecular sieve is more active for the selective oxyfunctionalization of n-hexane than any other heterogeneous catalyst reported in the prior art. Turnover rates (TOR=converted molecules/Ti sites/unit time) measured on TS-PQ titano-silicate molecular sieve at 45° C. and 1 atm are higher than the highest TOR values reported for TS-1 at 100° C. and ˜3 atm. n-hexane is reported to be the most reactive paraffin over TS-1, thus other paraffins require >50° C. activation temperatures.

The presence of octahedral Ti⁴⁺ species including detectable amounts of Anatase (one form of crystalline TiO₂) is not detrimental on either the catalytic activity of TS-PQ titano-silicate molecular sieve or its selectivity for the efficient use of H₂O₂. Many TS-1 related papers emphasize that having exclusively tetrahedral, isolated Ti⁴⁺ ions on the place of Si⁴⁺ ions in the pentasil silicalite lattice is important for optimum catalyst performance. Octahedral Ti⁴⁺ contamination is considered to reduce H₂O₂ efficiency, because such ions promote the spontaneous decomposition of H₂O₂. H₂O₂ is an environmentally benign but expensive oxidant, and hence, its effective utilization for the oxidation of hydrocarbons is a key consideration in catalyst selection.

TS-1 is considered to be hydrophobic and organophilic (similar to MFI silicalites), but TS-PQ titano-silicate molecular sieve preferably adsorbs H₂O over hydrocarbons.

Unlike TS-1, TS-PQ titano-silicate molecular sieve does not need a co-solvent to generate and stabilize catalytically active sites for the oxidation of paraffins with aqueous H₂O₂.

Methanol as co-solvent reduces the catalytic activity of TS-PQ titano-silicate molecular sieve while it increases the catalytic activity of TS-1.

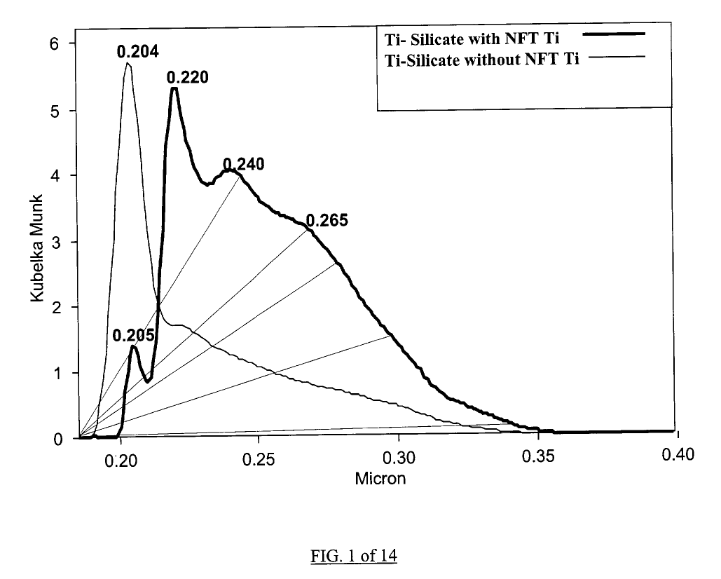

In-situ UV measurements were conducted to gauge the effect of H₂O and H₂O₂ on TS-1 and TS-PQ molecular sieve samples. Results are summarized in FIGS. 1-3. The UV spectra of samples dehydrated at 10⁻³ Pa and 25° C. as well as the UV spectra of the same material when soaked in H₂O, H₂O₂ at pH˜7, and H₂O₂ at pH˜4, respectively, are presented. These latter conditions mimic the catalysts in the catalytic reactor.

Dehydrated TS-1 does not have significant adsorption below ˜210 nm and the chief adsorption band of TS-PQ molecular sieve is at around 220 nm in the usually tested <200 nm range.

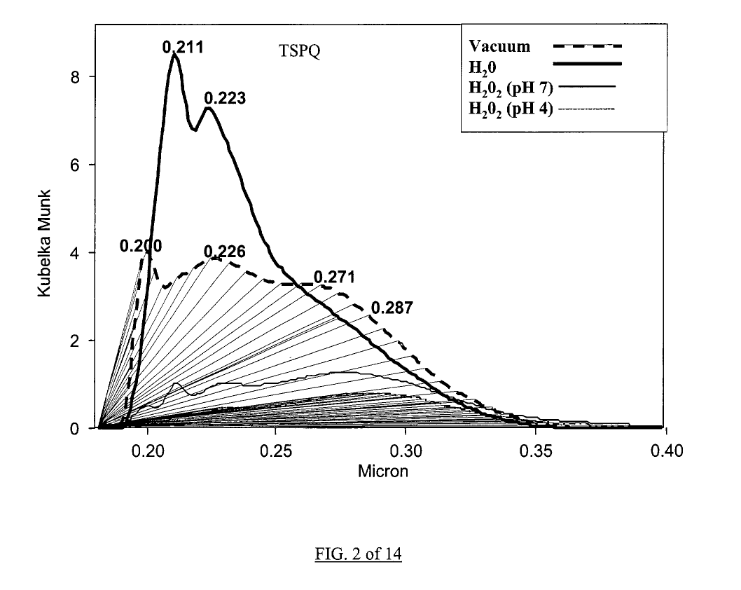

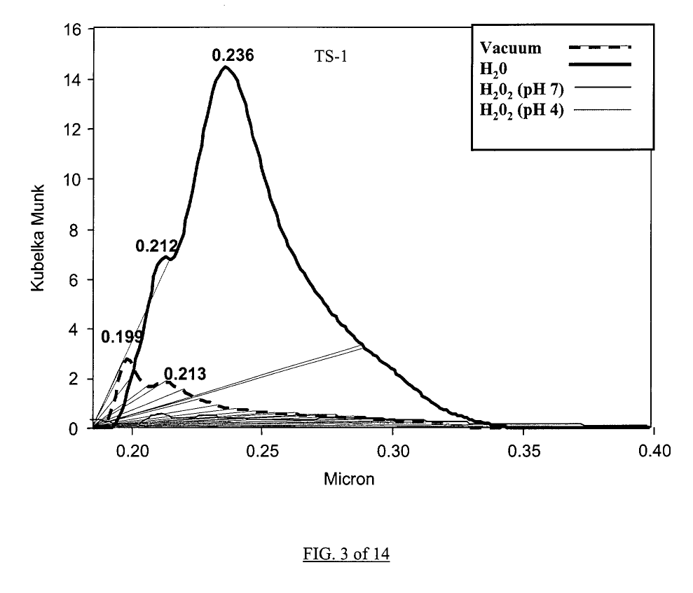

H₂O substantially increases the 210 nm band of TS-PQ molecular sieve (FIG. 2). In contrast, water generates a significant absorption band at 240 nm over TS-1(FIG. 3).

On TS-1, the peaks near 210 nm, 230 nm, and 290 nm are similar to each other in the presence of H₂O₂ both at pH˜7 and pH˜4. In contrast, largely only the 290 nm band remains on TS-PQ molecular sieve at pH˜4.

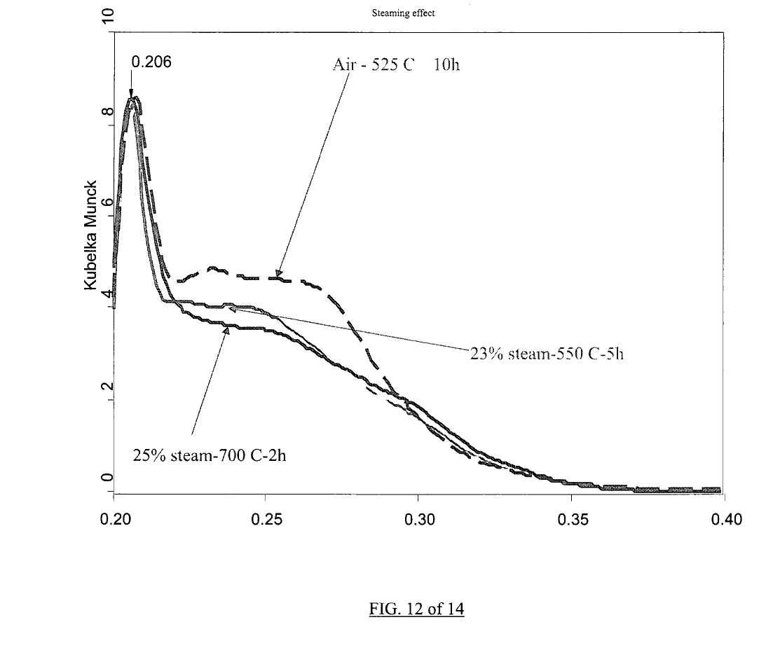

Without limitation, both of these empirical observations are consistent with TS-PQ having significantly greater amounts of highly dispersed Ti-species associated with the external surface of the silicate crystal. Further evidence for the presence of surface Ti species on TS-PQ is seen in FIG. 12 where strong acid extraction of a closely related titanosilicate material eliminates the absorbance band above 210 nm (Example 9). Similarly, the higher catalytic activity of TS-PQ can be seen as a direct result of the accessibility of reactants to the surface Ti species.

### SYNTHESIS EXAMPLES

The following examples are included to more clearly demonstrate the overall nature of the synthetic processes of the present invention. These examples are exemplary, not restrictive, of the present invention.

### Example 1

This example illustrates the preparation of a Ti-silicate molecular sieve according to the first embodiment of the invention.

In a method for preparing a titanium-silicate molecular sieve, 745.0 g of deionized water were added to 1505.2 g of 40% tetrapropylammonium hydroxide solution in water (40% TPAOH:SACHEM, low-sodium product #746) in a stainless steel beaker. The mixture was agitated and heated to 80° C. At this temperature, 775.0 g of “polyolefin catalyst” (PQ CS2040) grade silica gel (8.3% loss on ignition, screened through 325 mesh) were added to the TPAOH solution to achieve a TPAOH/SiO₂ mole ratio of 0.25. Heating was continued for 3 hours, and then the heat was turned off. The mixture was allowed to cool to room temperature overnight with agitation. Weighing showed that the mixture lost 480.4 g of water by evaporation. Therefore, the starting H₂O/SiO₂ 8.0 mole ratio had decreased to 5.8 in the resulting TPA-silicate solution. 83.1 g of Ti-butoxide, 97% (Aldrich) were dissolved in 249.3 g of 99.5% 2-propanol (Aldrich) and this solution was admixed with the silicate solution, giving a TiO₂/SiO₂ mole ratio in the final mixture equal to 0.02. The mixture was allowed to agitate for 5 hours at room temperature. After this, the mixture had the appearance of a viscous, opalescent, colloidal solution.

1429 g of that solution was placed into a 2 liter stainless steel (Parr) autoclave, equipped with a propeller stirrer. The rest of the mixture was used in the crystallization described in Example 2. The autoclave was heated for 1 hour to 80° C. and held at 80° C. for 24 hours, which is referred to herein as the pretreatment step. Then, the temperature was raised to 160° C. for 1 hour and held at 160° C. for 48 hours, referred to herein as the crystallization step. During both steps, the mixture was agitated by stirring at 450 rpm. The product recovered from the autoclave after cooling appeared as a milk-like slurry, with a thin layer of clear, organic-enriched liquid at the top.

The slurry was divided into two halves. The first half of the slurry was diluted to 2 liters by deionized water, and then the pH was adjusted to 9.0 by addition of 10% nitric acid, and in 20 minutes readjusted with the same acid to a pH of 2.5. The precipitate was filtered on a buchner funnel, washed during filtration with 6 liters of hot (80° C.) deionized water acidified to a pH of 3.5 by nitric acid. The second half of the slurry was also diluted with deionized water to 2 liters, and then heated to 80° C. Immediately after the heat was turned off, the pH was adjusted with 10% nitric acid to 8.5, and after 20 minutes. agitation, again readjusted to 5.2. The precipitate was washed during filtration with 3 liters of hot (80° C.) 0.1% nitric acid followed by 3 liters of hot deionized water.

Materials from the both halves were dried at 110° C. overnight and then calcined under static air at 550° C. for 9 hours, with a 5 hour heating period from ambient or room temperature to 550° C., at a rate of 1.75 degree/min.

Both samples appeared to be substantially identical by characterization data. On the XRD patterns, only reflections of MFI-type molecular sieve were present. Surface areas, measured by the BET method using nitrogen adsorption, were around 500 m²/g, while the micropore surface area was about 380 m²/g and the micropore volume was 0.16 cm³/g. This data demonstrated that the crystallinity of MFI-type titano-silicate was good. In addition the intensity ratio of 960 cm−1 peak(Si—O—Ti bonds) to 800 cm−1 peak (Si—O—Si) on FTIR spectrum was 1.25.

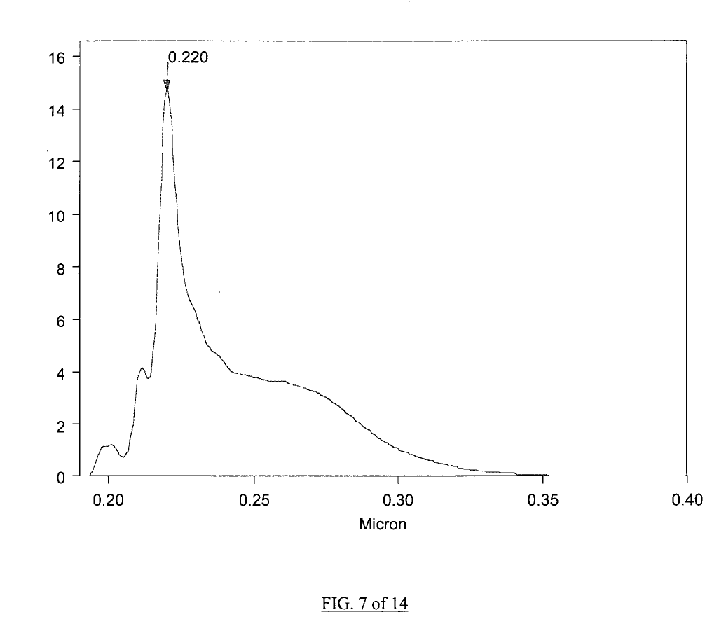

The TiO₂/SiO₂ mole ratio by XRF and XPS analysis was 0.022, practically the same as the starting gel ratio of 0.02. A calibration curve was prepared comparing the intensity of the Raman band at 144 cm⁻¹ a function of anatase concentration in the solid phase. Comparison of Raman data for the synthesis sample with this calibration curve showed that the anatase concentration in the samples must be below 50 ppm. FTUV DRV spectrum (FIG. 7) reveals high intensity peak at around 220 nm of high-energy Ti center, indicates some fraction of non-framework Ti (240-300 nm), and confirms the absence of a massive Ti-oxide phase (>300 nm). XPS data showed that the Ti concentration on the surface was exactly equal to bulk (by XRF) concentration and that Ti was approximately equally distributed between 4-coordinated tetrahedral and 6-coordinated octahedral sites on the surface of solid. The admixture levels for the main contaminants (determined by atomic absorption (AA) and inductively coupled plasma (ICP) methods) were about 60 ppm for Al, 40 ppm for Fe, 70 ppm for Na, and 200 ppm for Ca. SEM micrographs showed that the size of crystal grains in the products is around 100 nm, while TEM revealed that the main crystal shape is a rather isometric rectangular prism with maximal dimensions of 60-70 nm.

### Example 2

The remainder of the mixture left in Example 1 (mixture #1) had a gel mole formula: 0.25 TPAOH:0.020 TiO₂:1.00 SiO₂:5.78 H₂O:0.080 BuOH:0.35 2-PrOH, where BuOH is butanol, formed as a result of hydrolysis of Ti-butoxide, and 2-PrOH is 2-propanol. In addition to that mixture, another one (mixture #2) was prepared by the same procedure. Its gel formula was: 0.24 TPAOH:0.019 TiO₂:1.00 SiO₂:4.97 H₂O:0.076 BuOH:0.33 2-PrOH. These two practically identical mixtures were placed in four different Parr autoclaves (A, B, C., and D) equipped with propeller stirrer and treated under the same conditions as those used in Example 1, with the only difference being the duration of 80° C. aging.

In order to assess the effect of time on crystal size in the pretreatment step (step c) of the first embodiment, various pretreatment times were used for four different autoclaves. In an effort to specify the required scope of this pretreatment, additional SEM data of molecular sieve samples prepared with different pretreatment times were obtained. The SEM definition of crystal size is not precise because the dimensions of very small crystals are poorly resolved. Nonetheless, estimation of crystal size by examination of about two dozen grains in each SEM photograph provides the data in Table 1 below.

TABLE 1
Estimated crystal size of titano-silicate preparations

| | Pretreatment | Crystal Size |
|---|---|---|
| Mixture/Autoclave | Conditions | (SEM Estimation) |
| 1/A | 80° C./0 hour | 300-500 nm |
| 1/B | 80° C./6 hours | 200-250 nm |
| 2/C | 80° C./12 hours | 140 nm |
| 2/D | 80° C./24 hours | 120 nm |

From Table 1, one can see that there is only a rather small additional decrease in crystal size for a 24 hour pretreatment at 80° C. as compared with pretreatment for 12 hours. The difference is difficult to distinguish at this size range and resolution. For less than a 12 hour pretreatment, the size of crystals begins to increase significantly so that a 12-24 hour pretreatment stage at 80° C. seems to be preferred for the present invention. To obtain still smaller crystals, it will be necessary to reduce the age or pretreatment temperature, increase age time and/or increase the TPAOH/SiO₂ ratio above the current 0.25 value used in these experiments.

### Example 3

This example illustrates preparation of a sample especially active in hexane oxidation (see catalysis examples, infra.), with Ti centers, characterized by predominance of ˜220 nm band on UV DRV spectra.

949.8 g of a colloidal silica sol, containing 34% silica and purified by dialysis, 2034DI (Nyacol) was admixed to 673.3 g of 40% TPAOH solution (SACHEM product #746). The solution was agitated for approximately 2 hours, and after this a solution of 31.1 g Ti-butoxide in 128.6 g of 2-propanol was slowly added to the mixture; agitation was continued for another two hours. The mixture, in which the final reagent mole ratio was TPAOH:SiO2:TiO2:H2O:BuOH:PrOH=0.25:1.00:0.016:10.6:0.06:0.4, was placed into a 2 L autoclave and run under conditions: 80° C./3 days+160° C./2days; 450 rpm. The solid was separated by centrifuging (3700 rpm, 30 min), and washed with 10% ammonium nitrate solution and then with deionized water. The sample was dried at 110° C. and calcined in air for 9 hours at 550° C. with ramping to this final temperature over 5 hours. XRD analysis showed the presence of phase pure product having the characteristic MFI structure with crystallinity of a calcined sample above 90%. As-synthesized product, dried at 110° C., contained 9.3% carbon and 0.8% nitrogen, which is reasonably close to the C/N proportions expected for a TPA-species. Total weight loss to 500° C. (by TGA) was about 13%, corresponding to the presence of about four moles of a TPA-species per unit cell of the as-synthesized MFI-molecular sieve. The calcined sample had a FTIR 960/800 cm−1 peak ratio of 1.31; n-hexane adsorption 13.6%; N₂ BET micropore volume 0.164 cm3/g and mesopore surface 70 cm2/g. All these properties are consistent with very high purity and high crystallinity material. XRF elemental analysis gave for the atomic ratio of the solid product Ti/Si=0.018. Given the limits of the error of that analysis this ratio is practically identical to the value in the starting mixture, demonstrating that Ti incorporation in the solid phase during crystallization was effectively complete. This result is also in agreement with the mother liquor analysis showing a Ti/Si ratio=0.007.

XPS data showed that the surface of this sample was significantly enriched in Ti with a total-Ti/Si ratio was 0.032 (against 0.018 by XRF). The same XPS data indicates that about 70% of this Ti is in octahedral coordination.

Contamination levels, determined by by AA and ICP analyses, were a little bit higher for Na, Al, Fe (Na=520 ppm; Al=370 ppm; Fe=180 ppm), then in the sample of example 1, due to the higher purity of the colloidal silica gel, used in example 1. Nevertheless, acidity of the sample by the TPD-TPAm (temperature programmed desorption of tripropyleamine) method was close to zero,=0.02+/−0.01. This sample had an intense peak in the 220 nm range on the UV-VIS DR spectrum (FIG. 1) and demonstrated superior performance in n-hexane oxidation, (see example 1).

### Example 4

This example demonstrates the preparation of Ti-silicate molecular sieve with predominantly tetrahedral isolated Ti-centers in the framework and illustrates the use an amine as a supplementary alkalinity source.

All reagents were mixed in an open stainless steal beaker in the following order: 540.6 g of 40% TPAOH water solution (SACHEM, #746); 378.9 g of 70% hexamethylenediamine (HMD) water solution (DUPONT); 2699.3 g of 8 weight percent colloidal silica sol, purified by dialysis (820DI, NYACOL); a solution of 53.7 g of 97% Ti-butoxide in 217.8 g of 99.5% 2-Propanol (both Aldrich). The mixture was agitated for 2 hours at room temperature and had the original reagent proportions: TPAOH:HMD:SiO2:TiO2:H2O:BuOH:PrOH=0.12:0.25:1.00:0.017:16.0:0.07:0.4. The mixture was heated to 80° C. and held at this temperature for 5 hours and was then allowed to cool to room temperature overnight. Agitation was continuous throughout this treatment.. As a result of this treatment the total weight of the mixture was decreased by 2001.3 g due to evaporation of alcohol and water. Attributing the weight loss to these components the final proportion of the mixture would be TPAOH:HMD:SiO2:TiO2:H2O=0.12:0.25:1.00:0.017:5.3. The resulting mixture was an opalescent, viscous, liquid with a pH=12.98. About 1400 g of this liquid was transferred to a 2 L autoclave and digested under the conditions: 80° C. for 72 h and 160° C. for 36 hours; with the stirrer operated at 450 rpm.

The milky product slurry, at pH 13.13, was coagulated by adding an excess of ammonium nitrate. The precipitate formed by this treatment was separated from the liquid phase on a Buchner funnel without washing.. After drying and calcinations in air (6 hrs at 550° C. following a 5 hour ramp from room temperature) the x-ray pure MFI product had a N2 BET micro pore volume of 0.164 cm³/g, a mesopore surface area of 93 cm²/g, and a n-hexane adsorption capacity of 13.06% with a 960/800 cm−1 peak ratio on the FTIR spectrum of 1.46. The Ti/Si atomic ratio by XRF was 0.016, but XPS results indicated some depletion of surface Ti to a Ti/Si atomic ratio of 0.011. XPS data indicated a predominance of tetrahedrally coordinated Ti (>60%).

Contaminations (by AA and ICP methods) were present at concentrations typical for Ti molecular sieves, synthesized with a colloidal silica source: Na=610 ppm; K=40 ppm; Al=390 ppm; Fe=120 ppm; Ca=35 ppm; Mg=6 ppm. Raman spectroscopy indicated the absence of any Ti-oxide phase. UVDRV spectra of this particular Ti-silicate preparation is characterized by an intense band at ˜210 nm indicating predominant incorporation of Ti into isolated framework positions. This spectrum is shown in FIG. 1

### Example 5

This example illustrates the preparation of a comparison TS-1-type material prepared by the conventional alkoxide method as in Example 3 of U.S. Pat. No. 5,691,266 (Onozawa et al). In the reproduction of that example, 20.8 g of Ti-ethoxide, tetraethoxytitanate, TEOT, (Aldrich) was added drop-wise at room temperature to 750 g of Si-ethoxide, tetraethylorthosilicate, TEOS, (Aldrich) stirred under the flow of dry nitrogen. The solution was heated to 35° C. and held with agitation at this temperature for 30 min. After this, the mixture was cooled below 20° C. by means of an ice bath. 647.7 g of 40%TPAOH solution (SACHEM, #746)was diluted with an equal weight of deionized water to get a 20% TPAOH solution, which was also cooled below 20° C. The cold TPAOH solution was added drop wise, with stirring, to the cold alcoxide solution over a period of 3 hours under nitrogen flow; stirring and nitrogen flow was continued as the mixture was allowed to warm to room temperature overnight. Next morning the mixture was heated uncovered at 75° C. for 1.5 hour until the smell of the ethanol hydrolysis product disappeared. Deionized water was added to the mixture to compensate for the weight loss due to volitilization and the adjusted mixture stirred for 20 minutes at room temperature. This procedure gives a mixture that corresponds to the formulation in the patent reference: TPAOH:SiO2:TiO2:H2O=0.36:1.00:0.025:20.0. The resulting, completely clear, liquid was placed into a 2 L autoclave and digested under the conditions: 170° C., 48 hours, 250 rpm.

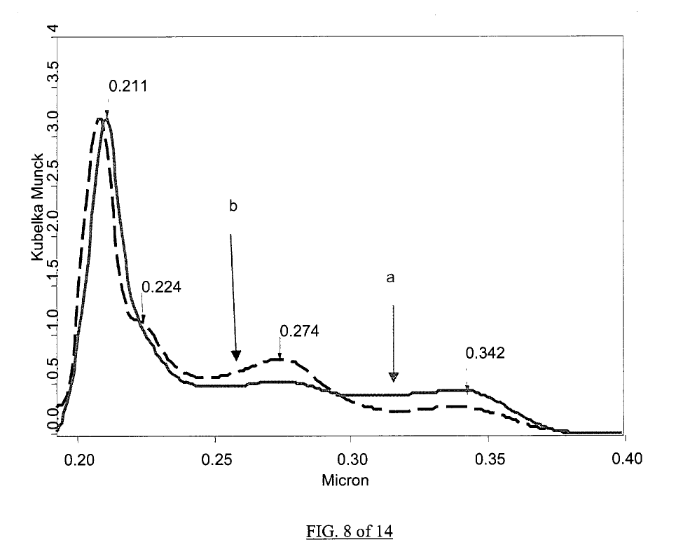

The product slurry (pH=12.52) was divided into two halves. The first half was treated in exact reproduction of the patent example. After adjusting the slurry pH to 8.1 by addition of 10% acetic acid; the resulting gel was centrifuged (3000 rpm, 30 min) to effect liquid/solid separation; the solids washed with deionized water, dried at 110° C. and calcined at 525° C. for 10 hours in air with a 5 hours ramp to this temperature. The product had an XRD crystallinity of 99%, a micro pore volume of 0.153 cm³/g, mesopore surface area 111 cm²/g, and FTIR 960/800 cm−1 peak ratio of 1.56. Ti/Si atomic ratio by XRF was 0.024. Raman spectroscopy, however, revealed a very significant anatase contamination estimated from the intensity of the 144cm⁻1 peak to be approximately 1 weight percent so that about half of the Ti in the product appears to have been precipitated as massive TiO₂ The presence of significant anatase contamination was further confirmed by detection in the less sensitive FTUV DRV spectrum—FIG. 8a.

The second half of the product slurry was treated by centrifugation (10,000 rpm for 2 hours) without pH adjustment in order to separate solid product from mother liquor. The separated solids were re-dispersed in deionized water and spun down again, then dried and calcined under the identical conditions used to treat the first half of the recovered crystallizer slurry. Despite the differences in treatment the characteristics of material recovered from both halves of the crystallizer slurry appear to be very close to each other, including high anatase contamination and similarity in FT UV DRV spectra as shown in FIG. 8b. Those spectra are characterized by a significant band at >300 nm indicative of massive Ti-oxide. The spectra also have a relatively low intensity band in the area 240-300 nm assigned to non-framework titano-silicate. In TSPQ material non-framework Ti centers typically appear as non-framework titano-silicate (240-300 nm), while in the alkoxide method such non-framework Ti appears mainly as a massive Ti-oxide phase.

### Example 6

This example illustrates synthesis in 30 gallon pilot plant autoclave.

58.8 pounds of deionized water were placed into a 30 gallon jacketed tank followed by 109.8 pounds of 40% TPAOH solution (SACHEM<#746). The mixture was agitated for 5 min and heated to 175 F. 29.0 pounds of silica catalyst (PQ CS2040) fines, having 10.6% moisture concentration, were charged slowly to the agitating solution at 175 F. over a one hour period., hold at that temperature for another hour, and then allowed to cool to ambient temperature overnight. Deionized water was added to the cooled solution to restore the original weight of 197.6 pounds. The solution in the autoclave at this step had a molar composition: TPAOH:SiO2:H2O=0.5:1.0:16.0. Five pounds of [TYZOR TE, 80% solution of triethanolamine titanate chelate in isopropanol (DUPONT)], was then added to the TPA-silicate solution and mixed for 3 hours. This solution was heated to 105° F. and an additional 29.1 pounds of silica catalyst fines were slowly charged into the 30 gallon jacketed tank over one hour. The heat was turned off and the mixture was agitated for 30 min more. The pH of the mixture was 12.4. At this point the 1 the oxide formula of the mixture was: TPAOH:SiO2:TiO2:H2O=0.25:1.00:0.01:8.1. After pumping the mixture into a 30 gallon autoclave crystallization was conducted under the following conditions: 4 hours heat-up ramp to 175° F.; hold 24 hours at 175° F.;4 hours ramp to 355° F.; digest 13 hours at 355° F. under continuous agitation with an anchor-type stirrer at 60 rpm.

A small part of the product-slurry was centrifuged at 10,000 rpm for 2 hours. The centrifuged solids were redispersed in deionized water and spun again, then dried and calcined in a shallow bed at 525° C.

XRD analysis showed a phase pure MFI-type fully crystalline product. Micro pore volume was 0.159 cm3/g and mesopore surface area was 113 cm2/g. Ti/Si (XRF) was 0.01 The FT UV-VIS VDR spectrum, shown on FIG. X9a, was characterized by two intense bands at 200 nm and 223 nm. A lower intensity band at 277 nm, indicated the presence of some non-tetrahedral Ti.

26.7 pounds of 10 percent nitric acid was added to the bulk of the synthesis slurry (141 lbs) at 80° F. forming at thick gel at pH 9.3. This thick gel was diluted with an equal weight of deionized water and thoroughly mixed, after which an additional 20.6 lbs of 10 percent nitric acid was added to bring the slurry pH to 2.6. Slurry solids were separated on a filter press and washed with 175 gallons of de-ionized water. Recovered filter cake was dried at 250° F. overnight and calcined at 1000° F. using a ramp rate of 5° F. per minute.

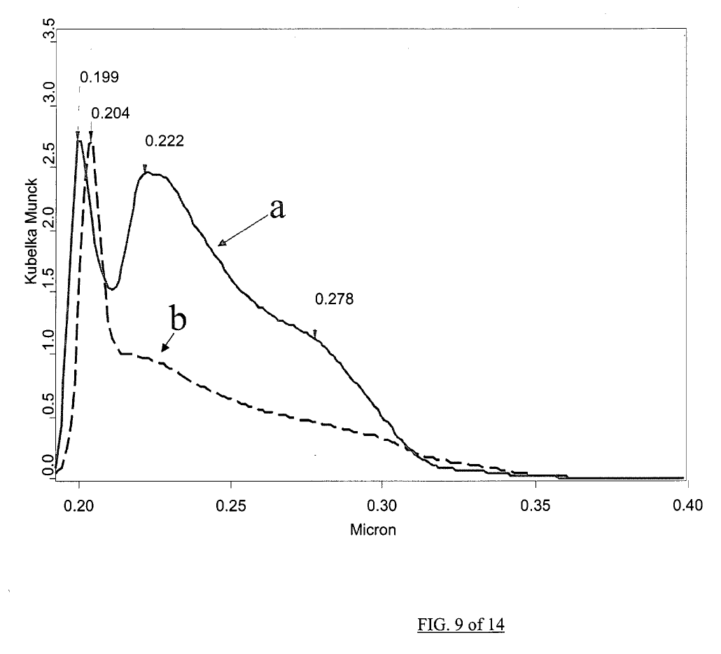

The crystalline product was phase pure with micropore volume of 0.158 cm3/g, mesopore surface area was 123 cm2/g and a Ti/Si atomic ratio by XRF of 0.01. No anatase contamination was detected in the Raman spectrum. FIG. 9b shows a UV spectrum that differs from that of the centrifuged sample from the same synthesis batch. The band at ˜220 nm is suppressed for the bulk material, indicating that acid treatment to a low pH removes at least some of the Ti species responsible for that band.

### Example 7

This example illustrates Ti-silicate synthesis using a titania-silica cogel.

A silica-titania co-precipitated gel was prepared. To reduce trace impurities the gel was given a mild acid wash with dilute sulfuric acid. After washing, the gel was found by analysis to contain the following trace elements with concentrations given in ppm: Al,50; Fe, 66; Ca, 26; Mg 9; Na 16; K10 with a Ti/Si mole ratio of 0.032 and an LOI of 13.6%. 410 g of this gel was added to a solution consisting of 720 g of 40% TPAOH solution in 380 g of deionized water at 50° C. and the mixture stirred for 10 minutes. The mixture (TPAOH:SiO2:TiO2:H2O=0.25:1.00:0.032:8.5) was placed into a 2 L autoclave and digested with agitation (450 rpm) in two stages under the following conditions: 80° C. for 24 hours; 160° C. for 48 hours.

Product slurry (pH=12.8) was centrifuged, separated solids re-dispersed in de-ionized water, and the process repeated two times before drying and calcining the material at 525° C. The Ti/Si mole ratio of the product was 0.029. XRD crystallinity was close to 100%. Raman spectroscopy revealed significant (1800 ppm) anatase impurity, and the UV-spectra also indicated the presence of non-framework Ti, thought to be due to high Ti concentration in the starting gel.

### Example 8

This example illustrates preparation of Ti-silicate molecular sieve under atmospheric pressure.

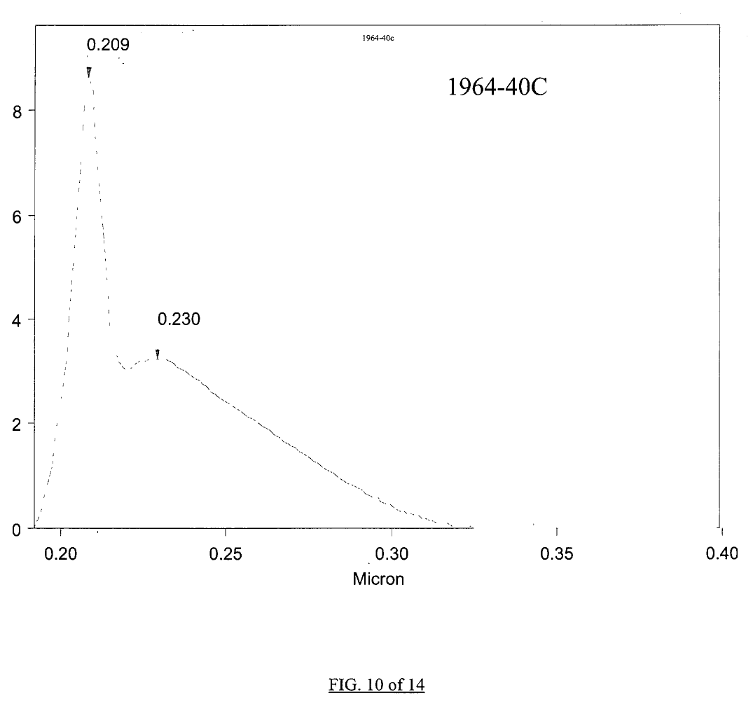

A synthesis mixture with the stoichiometric proportions TPAOH:SiO2:TiO2:H2O=0.25:1.00:0.013:10.6 was prepared by combining 1636.5 g of 40% TPAOH solution, 2312 g of colloidal silica, 2034 g of de-ionized water, with 60.2 g of Ti-butoxide in 170.2 g 2-Propanol. The mixture was agitated in an open beaker for 3 hours at 80° C. to eliminate alcohol. Assuming the weight loss to be due to evaporation of alcohol and water to the stoichiometric proportions above are changed to: 0.25:1.00:0.013:7.4. The mixture was then digested for 11 days with agitation in a closed vessel maintained at 80° C. by an oil bath. Samples were taken periodically, acid coagulated to pH 5.5, washed, dried and calcined as previously described. After 3 days digestion only the MFI phase was present in the solids at a level of approximately 20 percent relative to reference materials crystallized at high temperature. After 4 days digestion the relative crystallinity did not change and remained steady at 60-70 percent. Characterization of further samples gave micropore volumes in the range 0.152-0.157 cm³/g, with mesopore surface areas of 170-210 cm²/g. Crystal size estimated from SEM micrographs did not exceed 100-200 nm. This indicated constant noticeable presence of amorphous in low-pressure products. The bulk Ti/Si (XRF) atomic ratio of all samples was the same (0.013) as that of the starting mixture but by XPS analysis the surface Ti/Si ratio of the final product was 0.021, indicating surface enrichment by Ti. From the XPS characterization, this surface Ti is predominantly (85%) tetrahedral while the FTIR 960/800 cm−1 peak ratio was 0.92. Raman spectroscopy does not reveal the presence of anatase. Similarly, the FT UV- DRV spectrum confirmed the predominance of tetrahedral framework Ti in the sample, as well as presence of some amorphous Ti species.—FIG. 10.

### Example 9

This example illustrates the preparation of Ti-silicate molecular sieve with MEL type structure and remove of non-framework Ti by acid treatment.

281.8 g of 55% solution of tetrabutylammonium hydroxide (TBAOH, SACHEM) and 231.2 g of deionized water are combined in a stainless steel beaker and heated to 80° C. During this heating period, 131.8 g of silica catalyst fines were added over 30 minutes with agitation. When the mixture reached a temperature of 80° C., the beaker was covered, and the mixture was held at temperature with agitation for 4 hours and then allowed to cool overnight. An evaporative weight loss was compensated and the mixture cooled below 20° C. before the addition of 14.0 g of Ti-butoxide dissolved in 42 g of 2-Propanol. Agitation was continued at room temperature for 5 hours. Finally, the mixture was placed in a 1 L autoclave, and digested under the following conditions: 80° C. for 24 hours; 160° C. for 48 hours at 450 rpm with a propeller-type stirrer.

The product-slurry (pH=12.3) was diluted to 2 L by deionized water, heated to 80° C. and its pH adjusted to 8.3 using 10% nitric acid. The coagulated solids were filtered and washed with 6 L of deionized water acidified to pH3.5 with nitric acid. The filter cake was dried and calcined at 525° C. following previously described procedures.

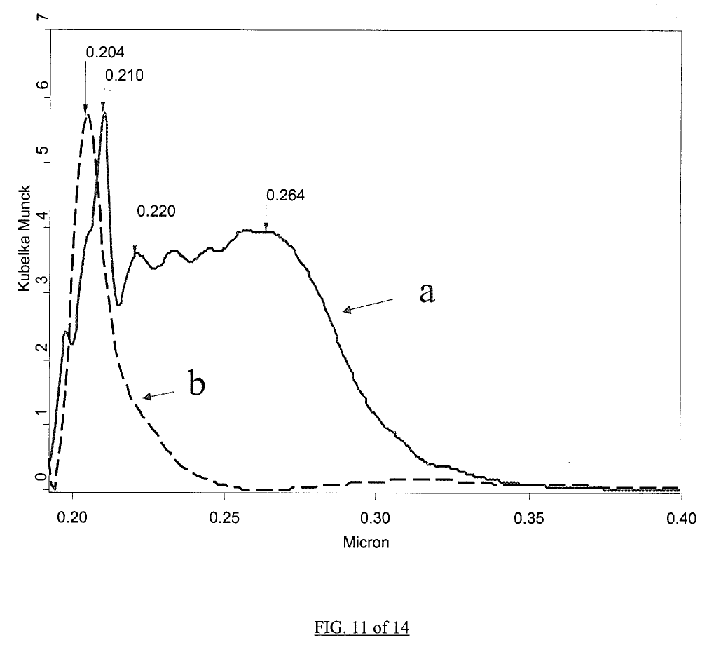

XRD analysis confirmed that the product possesses the MEL/MFI type molecular sieve structure and no other crystalline structures were detected. TEM (transmission electron microscopy) images showed the product to have the form of very fine plates with edge dimensions around 100 nm. Micropore volume was measured as 0.159 cm3/g. An increased mesopore surface area of 198 cm2/g relative to MFI material, is consistent with a highly developed external surface area for very small, thin, plates. The bulk Ti/Si atomic ratio (XRF) was 0.019 again close to that of the starting mixture. An FTIR 960/800 cm−1 peak ratio of 1.45 indicates a high concentration of Si—O—Ti bonds. Anatase, if present, was in concentrations below the sensitivity of Raman spectroscopy analysis, i.e.<50 ppm. FTUV-DRV spectrum measurements (FIG. 11a)revealed the presence of isolated tetrahedral framework Ti centers in the sample (210 nm band) together with a variety of other Ti centers (220-300 nm). Acid treatment experiments, reported below, suggest, that these other centers relate to Ti present on the external surface of the crystalline product. Shifting of UV adsorption bands towards the red end of the spectrum indicates higher coordination number and/or degree of polymerization of Ti oxygen polyhedra in these centers.

In an acid extraction experiment 80 g of the dried, but uncalcined product of this example were dispersed in 3 L of 2N HNO3 solution and agitated at 80° C. for 1 hour. The solid was washed to a pH of 3.5 and dried. The organic content of the as-synthesized sample and the sample after acid treatment was not changed as measured by TGA analysis and was around 15% of TBA-species. The acid-treated sample was calcined at 525° C. for 10 hours after heating to temperature over 5 hours. Crystallinity and adsorption characteristics of the acid-treated samples were practically the same as those of the untreated sample reported above, however, the bulk Ti/Si atomic ratio (XRF) and, therefore, the total Ti content were reduced nearly two-fold. The FTIR 960/800 cm−1 peak ratio was also decreased to 1.11 and the only band present in the UV-spectrum was the 204 nm band corresponding to tetrahedral Ti centers—FIG. 11b. In the un-calcined crystalline product, TBA species block the channel intersections preventing extraction of material from the crystal interior, and for this reason the internal surface of the molecular sieve is inaccessible to acid treatment, so the observed changes must be assigned only to the external surface.

### Example 10

This example illustrates effect of calcinations with steaming on Ti centers in Ti silicate molecular sieve.

Ti-silicate molecular sieve was prepared in a 30 gallon pilot plant autoclave. The solid was recovered by coagulation of the product-slurry by adjustment of slurry pH to 5.1 with 10% nitric acid. The bulk slurry was filtered, washed and flash dried. Three samples of this flash-dried Ti-silicate were calcined under different conditions.—FIG. 12. One sample was calcined in air following our regular laboratory procedure: 5 hours heat up to 525° C., 10 hours at 525° C. A second sample was calcined, inserting the sample directly into an oven controlled at 550° C. with a purge atmosphere containing 23 percent steam and holding under these conditions for 5 hours. A third sample was placed at ambient temperature in the same oven under a purge atmosphere containing 25 percent steam and heated at 5° C. per minute to 700° C. and held for 2 hours. All three samples had bulk Ti/Si atomic ratios of 0.02, 960/800 cm−1 FTIR peak ratios of 1.5 and kept the same crystallinity with micropore volume of about 0.15 cm3/g. However, their UV spectral characteristics, as shown in FIG. 12, were different. The intensity of the broad band attributed to non-framework, amorphous, titania-silica, was diminished with steaming.

### Example 11

This example compares crystalline products with different Ti/Si ratios after recovery by centrifugation or by acid coagulation.

Two different gel mixtures were prepared using the same 40% TPAOH solution, silica catalyst fines and Ti-butoxide in isopropanol reagents described previously. Gel (1) had reagent mole ratios TPAOH:SiO2:TiO2:H2O=0.25:1.00:0.01:8.14, in gel (2) the ratio was: 0.25:1.00:0.04:8.06. The essential formulation difference, being the fourfold increase in Ti/Si for gel (2) over gel (1). Both gels were converted to crystalline products following the same two-stage digestion procedure described in previous examples. Each crystalline product slurry was divided in half. The first half (1-1; 2-1) of each was centrifuged at 10,000 rpm for 2 hours; the solid, after decanting was re-dispesed in deionized water and spun down again. Recovered solids were dried, and calcined under conditions as previously described. The second half of each slurry (1-2, 2-2) was coagulated by addition of 10% nitric acid until a gel was formed at pH=8-9; slurry volume was doubled with deionized water to break up the gel and the pH readjusted to 3.5. Filtered solids were washed, dried and calcined as before. Characterization data for these samples is shown in following table 2.

TABLE 2
Comparison of Centrifuged and Coagulated Samples

| | 1-1 | 1-2 | 2-1 | 2-2 |
|---|---|---|---|---|
| Micropore vol., cm3/g | 0.158 | 0.155 | 0.160 | 0.156 |
| Ti/Si [mole] (XRF) | 0.009 | 0.010 | 0.023 | 0.035 |
| Ti-total/Si [mole] (XPS) | 0.008 | 0.011 | 0.022 | 0.076 |
| Ti-tetrahedral, % (XPS) | 85.3 | 81.3 | 49.4 | 17.7 |
| Anatase, ppm (RS) | <50 | <50 | ˜300 | ˜650 |
| 960/800 cm-1 peak ratio (FTIR) | 1.24 | 1.47 | 1.86 | 1.68 |

As can be seen from the tabulated data, the recovery procedure had only a modest effect on the products derived from the low-Ti starting mixture (1-1 and 1-2). However, the high-Ti products (2-1 and 2-2) show significant differences between products depending on whether they are recovered by centrifugation or coagulation. With the high Ti formulation the centrifuged sample: retains less total Ti, has less surface Ti, a larger percentage of framework (tetrahedral)

Ti, and less anatase contamination as compared with the coagulated sample from the same synthesis. In the coagulated products Ti species remaining in the mother liquor are precipitated, but in the low Ti synthesis nearly all the system Ti has been incorporated in the crystal structure.

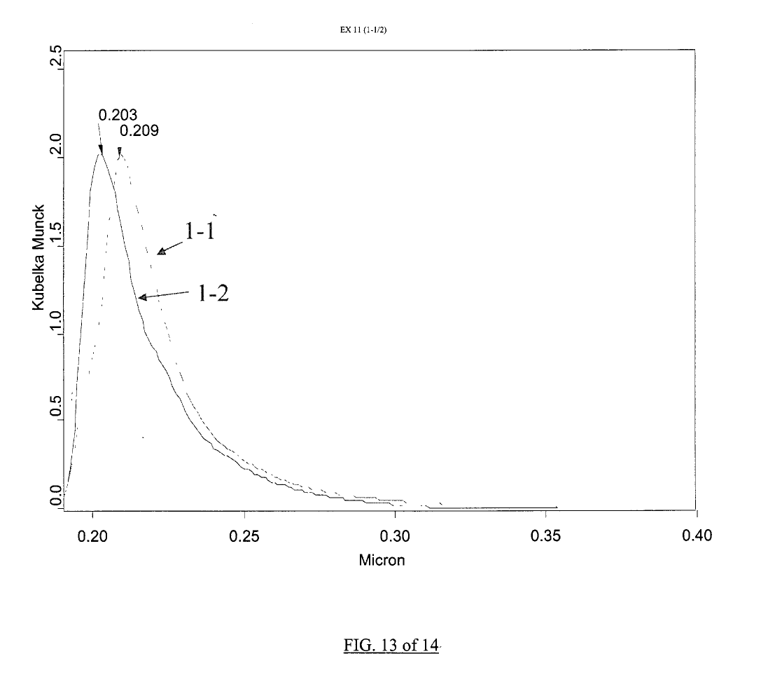

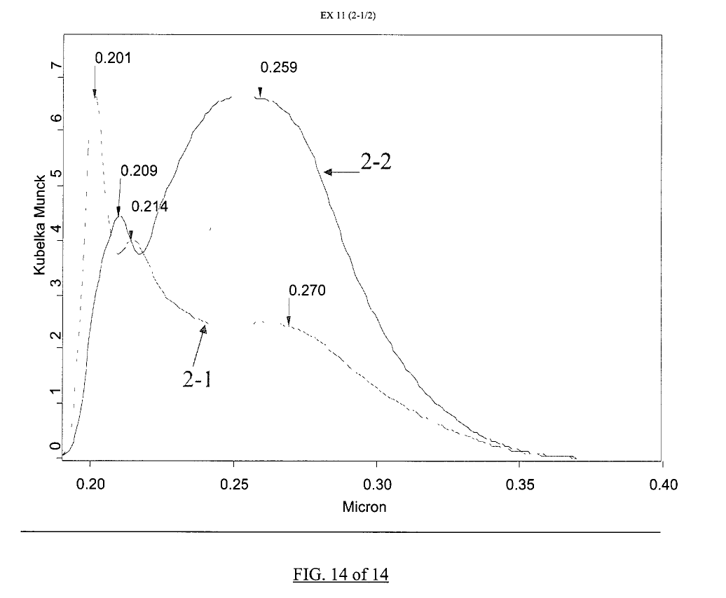

The UV spectra of these two sample sets are shown in FIGS. 13 and 14 and support this conclusion.

### CATALYSIS EXAMPLES

The degree of difficulty in inserting only one oxygen to form alcohols and oxo-compounds in a straight chain, saturated hydrocarbon or paraffin is well known. The problem is that initiating the reaction requires such harsh initiation conditions, that it does not terminate at a single oxygen insertion, but easily proceeds to multi-oxygenation or full combustion. TS-1 was the first effective heterogeneous catalyst that could initiate selective oxidation on paraffins with dilute aqueous H₂O₂ at temperatures below 100° C. (T. Tatsumi, M. Nakamura, S. Negishi, H. Tominaga, J. Chem. Soc., Chem. Commun., 476 (1990), D. R. C. Huybrechts, L. De Bruycker, P. A. Jacobs, Nature 345 (1990), 240.) A typical TS-1 catalyst contains mainly isomorphously substituted tetrahedral Ti atoms in an MFI type silicate framework. We compared the catalytic activity and selectivity of an isomorphously substituted TS-1 molecular sieve with TS-PQ titano-silicate molecular sieve, which was found to be more active and selective for this process than other heterogeneous catalysts known in the prior art. TS-PQ titano-silicate molecular sieve retained these excellent catalytic properties even in the absence of any homogenizing solvent. n-hexane is reportedly the most reactive paraffin over TS-1 when a non-reactive co-solvent, usually methanol or acetone, is added to the non-miscible hydrocarbon and aqueous phases.

In this experiment, the present inventors systematically checked the co-solvent effect, along with the effect of other fundamental reaction parameters on the catalytic activity and selectivity of TS-PQ titano-silicate molecular sieve in the oxyfunctionalization of n-hexane by aqueous H₂O₂.

Experimental

Catalysts and Materials

Pure n-Hexane (98%), Methanol (99.98%), Hexanol and Hexanone isomers (>98%), and 30% aqueous H₂O₂ from Fluka and Sigma-Aldrich were used for catalytic tests and GC analysis. The accurate concentration of H₂O₂ was periodically determined by permanganometric titration. TS-PQ molecular sieve was made according to the methods of the present invention, and used in powder form for catalytic measurements. The average particle size of this MFI type crystalline material was 0.1-0.3 mm based on Hitachi 3500N SEM measurements. The nominal Si/Ti ratio was ˜55. According to laser Raman quantification, the calcined product contained ˜200 ppm Anatase (TiO₂).

Catalytic Measurements and Product Analysis

A 100 mL volume glass reactor equipped with a water-cooled reflux, a stirrer, and a Type JJ9 Cole Palmer redox (ORP) electrode was heated externally by an electromantle controlled by a Staco Series 500 temperature controller and a thin (1/64″) type T thermocouple place inside the reactor below the liquid level. A variable speed magnetic stirrer was used for experiments with <1000 rpm, and a PolyScience Model X-120 homogenizer for stirring rates from 5000 to 30,000 rpm. A Masterflex liquid pump dosed the necessary amount of 30% aqueous H₂O₂ into the reactor from a Teflon container placed onto an Ohaus Precision Standard balance. An ORP controller started and stopped the liquid pump automatically to maintain ˜0.1 mol H₂O₂/L concentration in the reactor. The weight change of the H₂O₂ container was registered every 20 secs. during the catalytic process, and end of the reaction was designated to be when the signal from the balance did not change for 10 minutes or more.

For the catalytic test, a desired amount of catalyst powder was weighed into the reactor first and saturated with 0.6 mL aqueous 30% H₂O₂ solution per gram zeolite (˜200 mmol H₂O₂/mmol Ti⁴⁺). After adding the necessary amount of n-Hexane, the stirrer was started and the heater was set. Table 3 contains details of the reaction conditions.

TABLE 3
Experimental conditions in oxyfunctionalization of
n-hexane over TS-PQ

| | | Catalyst | MetOH/ | | | H₂O₂ |
|---|---|---|---|---|---|---|
| | | Loading | n-Hex. | | | Pump. |
| | Temp. | (HTi) | Ratio | | Stirring | Rate |
| Exp. | (T) | [mol n-Hex./ | (MOH) | | Rate | (V) |
| # | [° C.] | mol Ti] | [mL/mL] | pH | [rpm] | [mL/min] |
| 1 | 40 | 1.28 | 0.0 | 4 | 500 | 0.5 |
| 2 | 40 | 0.64 | 0.5 | 9 | 5000 | 1.0 |
| 3 | 40 | 0.10 | 1.0 | 7 | 10000 | 2.0 |
| 4 | 50 | 1.28 | 0.5 | 7 | 5000 | 2.0 |
| 5 | 50 | 0.64 | 1.0 | 4 | 10000 | 0.5 |
| 6 | 50 | 0.10 | 0.0 | 9 | 500 | 1.0 |
| 7 | 60 | 1.28 | 1.0 | 9 | 5000 | 0.5 |
| 8 | 60 | 0.64 | 0.0 | 7 | 10000 | 1.0 |
| 9 | 60 | 0.10 | 0.5 | 4 | 500 | 2.0 |
| 10 | 40 | 1.28 | 1.0 | 7 | 500 | 1.0 |
| 11 | 40 | 0.64 | 0.0 | 4 | 5000 | 2.0 |
| 12 | 40 | 0.10 | 0.5 | 9 | 10000 | 0.5 |
| 13 | 50 | 1.28 | 0.0 | 9 | 10000 | 2.0 |
| 14 | 50 | 0.64 | 0.5 | 7 | 500 | 0.5 |
| 15 | 50 | 0.10 | 1.0 | 4 | 5000 | 1.0 |
| 16 | 60 | 1.28 | 0.5 | 4 | 10000 | 1.0 |
| 17 | 60 | 0.64 | 1.0 | 9 | 500 | 2.0 |
| 18 | 60 | 0.10 | 0.0 | 7 | 5000 | 0.5 |

After reaction, the liquid phases were homogenized with methanol and analyzed using an HP-6890 type GC-MS using a 30 m/250 mm HP-19091N-133 capillary column and temperature programming between 35 and 120° C.

Blank experiments without catalyst at 50° C. indicated immeasurably low H₂O₂ consumption during a period of 120 minutes which is substantially longer than the longest oxidation time at experimental reaction conditions (˜60 min). Therefore, it appears that spontaneous H₂O₂ decomposition or homogeneous hydrocarbon oxidation does not occur at these conditions. Blank experiments with only H₂O₂ on the catalyst without n-Hexane were meaningless in this experimental design. The utilization of H₂O₂ for hexane oxidation versus decomposition was calculated from the material balance of reacted n-Hexane and H₂O₂ molecules according to the following stoichiometry:

CH₃—CH₂—CH₂—CH₂—CH₂—CH₃+H₂O₂→CH₃—CHOH—CH₂—CH₂—CH₂—CH₃+H₂O

CH₃—CHOH—CH₂—CH₂—CH₂—CH₃+H₂O₂→CH₃—CO—CH₂—CH₂—CH_{2—CH}₃+2H₂O

Spectroscopy

A Nicolet Magna 550 FTIR, Kaiser Optical Systems HoloProbe laser Raman, and a Bruker IFS66/S spectrometer with variable Fourier transform capability from the far IR (˜100 cm⁻¹) to the deep UV (˜190 nm) range were used for measuring various properties of TS-PQ titano-silicate molecular sieve material.

Raman measurements were made at atmospheric conditions in a homemade sample holder providing ˜90 mW laser power on the sample. The sample container was attached to a Mark II type probe connected via fiber optics to a 200 mW Nd:YAG diode pumped laser (frequency doubled to 532 nm) and a charge coupled device (CCD) detector.

All other spectroscopic measurements were carried out either at atmospheric conditions using a single bounce diamond attenuated total reflectance (ATR) accessory from ASI Applied Systems or in ˜10⁻³ Pa vacuum using a diffuse reflectance (DRIFT) cell from Harrick Scientific. The DRIFT cell was equipped with CaF₂ windows and can be heated externally up to 600° C. which corresponds to ˜400° C. measured directly in the sample. By switching beam splitters and detectors, the in situ calcined and evacuated samples could be characterized in the full range from 900 to 52,000 cm⁻¹. All DRIFT measurements were made after cooling the sample to room temperature using either a CaF₂ or a Teflon background and results were converted to Kubelka-Munk units. Liquid nitrogen cooled MCT, InSb, and D-530/2 type PMT (photo multiplier tube) detectors were used for measurements in the MIR, NIR, and UV ranges, respectively.

Statistical Experiment Design and Data Analysis

The JMP software from SAS Institute was used to design a representative set of experiments to evaluate the effects of various reaction parameters on the rate of reaction and the distribution of products. The Pareto plots presented permit visualization of the orthogonally normalized, scaled estimates of the impact of variables on the conversion, selectivity, and other characteristics of the process.

Results

Design of Catalytic Experiments

The prior-art reaction conditions for the selective oxyfunctionalization of n-hexane with H₂O₂ over TS-1 vary widely. Typically, results are reported on batch experiments carried out using a specific set of reaction variables chosen by the investigator, and this makes the comparison of results across experiments extremely difficult. In those references that give the necessary information to calculate the nominal Si/Ti ratio of molecular sieve, it varies between about 30 and 90; the reaction temperature varies from 50 to 100° C., the contact time from 1 to 24 hours, the reactant ratio from 0.5 to 3.5 [mol n-hexane/mol H₂O₂], the catalyst loading from [0.04 to 1.5 mol n-hexane/g TS-1], and the solvent content from 0 to around 11 [mL methanol or acetone/mL n-hexane].

To design a finite, statistical set of experiments for TS-PQ molecular sieve, the present inventors considered these experimentally probed parameter ranges for setting minima and maxima of reaction variables. It was found that a total of 7 variables might fundamentally affect the reaction outcome in an experimental arrangement. One of them, the effect of stabilizer additive in H₂O₂, gave only two choices (present or not) while the others were calculated with three values near the minimum, middle, and maximum of their ranges. Thus, the L₁₈ (2¹×3⁷) type mixed level orthogonal array was selected as an experimental design that permits statistically significant correlations with results from 18 experiments. Table 3 shows that in the ultimate reaction parameter arrangement, only the 6 three level variables were explored, and no experiments with non-stabilized H₂O₂ solution were attempted.

To probe the effect of temperature, 40, 50, and 60° C. were selected because the inventors have never observed conversion below 40° C. and the atmospheric reactor did not allow experiments above 60° C. (H₂O and hexane can form an azeotrope with a boiling point of 61.6° C.). The amounts of n-hexane and catalyst were adjusted according to the limiting 100 cm³ reactor volume to cover the common catalyst loading range. Only methanol was used as co-solvent with ≦1 [MetOH mL/n-hexane mL] ratio because it was deemed the addition of more co-solvent was impractical. It is well known that H₂O₂ can oxidize both at acidic and basic conditions. Thus, the pH of the H₂O₂ solution was adjusted with either HNO₃ or NH₄OH to 4, 7, and 9 before pumping it into the reactor. The last two columns of Table 4 show the selected stirring rates and H₂O₂ pumping speeds that were specific parameters for the experimental reactor setting.

Catalytic Results and Catalyst Properties

Table 4 summarizes the results of catalytic experiments. Note that two, Experiments 6 and 18, were not done. The first and second columns show the amount of n-hexane before reaction and the total amount of H₂O₂ added to the reactor. The third column shows the titanium sites in the sample which is needed to calculate the reaction rates assuming that each Ti⁴⁺ ion is part of an active center ensemble. The composition of the organic phase after reaction is shown in the last 5 columns. Neither primary oxygenated products nor dual oxygenates were found in measurable amounts. With our experimental setup, the reaction time in column #4 was also a dependent variable.

TABLE 4
Results of catalytic experiments at conditions according to TABLE 3.

| | Reactants | | Ti | Time of | Products from GC Analysis | | | | |
|---|---|---|---|---|---|---|---|---|---|
| Exp | n-Hexane | H₂O₂ | centr. | react | n-Hexane | 2-ol | 3-ol | 2-on | 3-on |
| # | [mmol] | [mmol] | [mmol] | [sec] | [mmol] | [mmol] | [mmol] | [mmol] | [mmol] |
| 1 | 297.8 | 7.04 | 232.3 | 179 | 290.8 | 0.50 | 0.00 | 2.23 | 3.77 |
| 2 | 148.9 | 0.00 | 232.3 | 0 | 148.9 | 0.00 | 0.00 | 0.00 | 0.00 |
| 3 | 101.5 | 4.10 | 1515.4 | 3590 | 97.9 | 0.00 | 0.00 | 0.50 | 3.06 |
| 4 | 148.9 | 0.00 | 116.0 | 0 | 148.9 | 0.00 | 0.00 | 0.00 | 0.00 |
| 5 | 190.0 | 62.12 | 232.1 | 879 | 127.9 | 7.50 | 1.12 | 25.27 | 28.19 |
| 6 | 300.0 | 0.00 | 3030.8 | na. | na. | na. | na. | na. | na. |
| 7 | 148.9 | 0.00 | 116.0 | 0 | 148.9 | 0.00 | 0.00 | 0.00 | 0.00 |
| 8 | 297.8 | 6.80 | 466.2 | 3610 | 291.1 | 2.63 | 0.00 | 0.50 | 3.61 |
| 9 | 190.0 | 115.07 | 1515.4 | 1676 | 116.7 | 18.40 | 7.88 | 2.57 | 18.18 |
| 10 | 148.9 | 0.00 | 116.0 | 0 | 148.9 | 0.00 | 0.00 | 0.00 | 0.00 |
| 11 | 297.8 | 12.55 | 466.2 | 559 | 278.3 | 1.42 | 0.00 | 2.34 | 14.23 |
| 12 | 148.9 | 0.00 | 1515.4 | 0 | 148.9 | 0.00 | 0.00 | 0.00 | 0.00 |
| 13 | 297.8 | 0.00 | 232.1 | 0 | 297.8 | 0.00 | 0.00 | 0.00 | 0.00 |
| 14 | 148.9 | 0.00 | 232.1 | 0 | 148.9 | 0.00 | 0.00 | 0.00 | 0.00 |
| 15 | 148.9 | 55.58 | 1515.4 | 3892 | 144.1 | 2.08 | 0.00 | 0.20 | 2.52 |
| 16 | 148.9 | 46.89 | 116.0 | 1337 | 144.3 | 2.08 | 0.00 | 0.00 | 2.52 |
| 17 | 148.9 | 0.00 | 232.1 | 0 | 148.9 | 0.00 | 0.00 | 0.00 | 0.00 |
| 18 | 300.0 | 0.00 | 3030.8 | na. | na. | na. | na. | na. | na. |

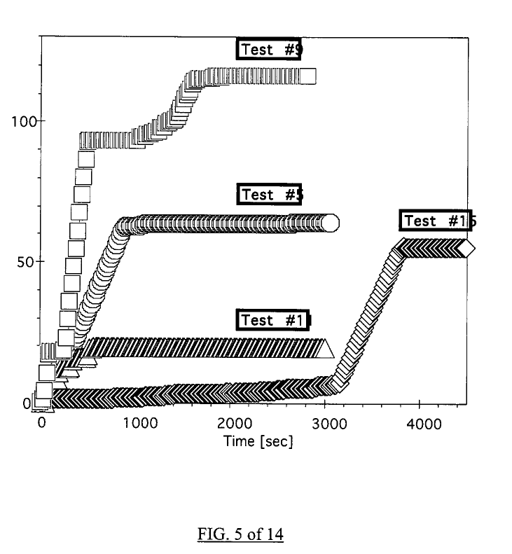

It was found that reactions stopped before reaching total hydrocarbon conversion despite ample H₂O₂ supply. FIG. 5 shows a few examples for typical catalytic runs. The initial H₂O₂ consumption can be either steep (test #9) or flat (Test #15) followed by either monotonously (Tests #5 and #11) or stepped (Tests #9 and #15) H₂O₂ consumption until a steady state condition is reached, i.e., no more oxidation takes place. The reasons for the delayed steps or the total reaction stops are not clear. It is possible that confined oxidation products gradually block access to the active sites. As Table 4 indicates, the reaction time from the beginning of H₂O₂ consumption until it stops can vary from a few minutes to about one hour.

In the 16 experiments presented, the turnover rates varied from TOR=0.04 (Experiment #3; not counting zero conversions) to TOR=18.3 [mmol n-hexane/mmol Ti/min] (Experiment #5). In addition, the selectivity of TS-PQ molecular sieve for utilizing H₂O₂ was also excellent as is seen at the conditions of experiment #5.

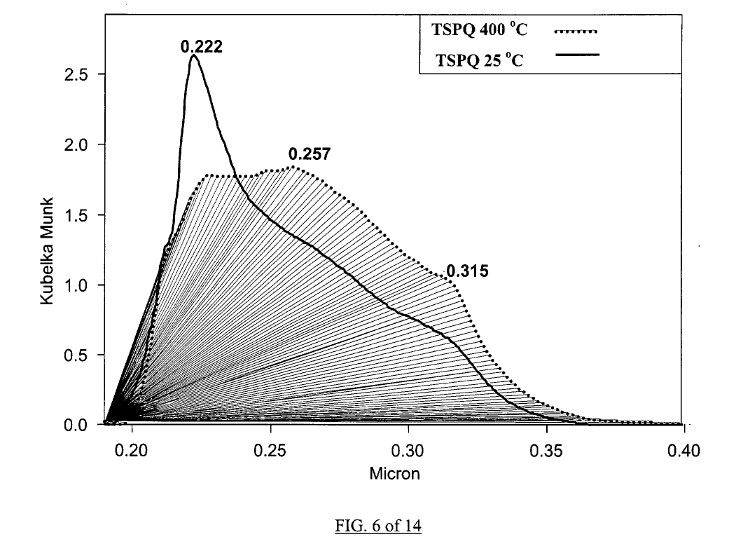

The high-resolution FT-UV spectra in FIG. 6 demonstrate that, unlike a typical TS-1 that contains mainly isomorphously substituted, isolated, tetrahedral Ti⁴⁺ ions with an adsorption maximum at <210 nm [4, 34, 36, 51-56], TS-PQ molecular sieve has substantial Uv absorption above 220 nm especially when dehydrated at 400° C. The adsorption near 220 nm is probably associated with non-isolated tetrahedral Ti⁴⁺ ions that appear sometime in the spectra of certain amorphous SiTiOₓ gels and that have also been observed in acid treated Ti-MWW. Adsorption above approximately 300 nm is typical for crystalline TiO₂ while the adsorption bands from 230 to 290 nm are likely due to variously coordinated octahedral Ti⁴⁺ ions. The effect of high temperature dehydration on the coordination conditions of Ti⁴⁺ ions in TS-PQ molecular sieve is exactly the opposite of those reported over some defect-free isomorphously substituted TS-1 materials which show an increase in the adsorption band at ˜208 nm upon dehydration.

The well-known 960 cm⁻1 vibration associated with Ti—O—Si bonds is present in the FTIR spectra of both the room temperature and the 400° C. evacuated samples of TS-PA molecular sieve. Therefore, the titanium atoms of TS-PQ molecular sieve appear to remain primarily chemically bound to the MFI structured silicate lattice after high temperature treatment.

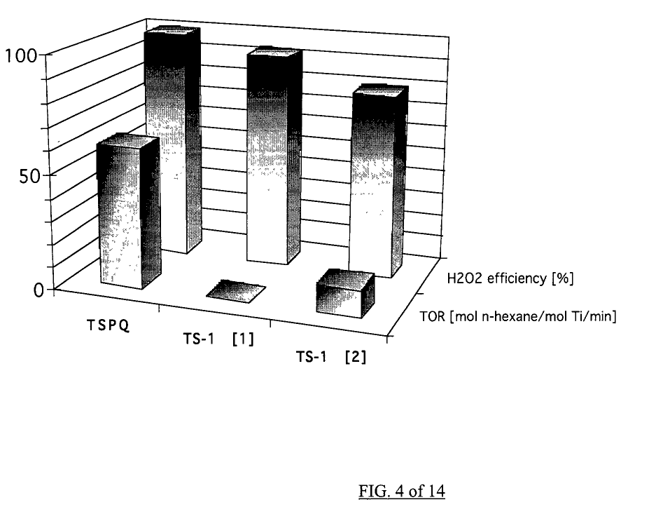

In summary, the oxidation of n-hexane by 30% aqueous H₂O₂ was completed in about 30 to 60 minutes over TS-PQ titano-silicate molecular sieve catalyst. The reported reaction times span from 1 to 24 hours over other heterogeneous catalysts. Especially high reaction rates were observed in the absence of solvents. FIG. 4 compares the best reaction rates measured on TS-PQ molecular sieve catalyst with data published for other catalysts (TS-1[8] is U.S. Pat. No. 5,126,491; TS-1[9] is D. R. C. Huybrechts, P. L. Buskens, P. A. Jacobs, J. Molec. Catal. 71, 129 (1992).) This figure also indicates that H₂O₂ was utilized with over 99% efficiency for hexane oxidation, while >7% loss has been typical in the prior art over TS-1 catalysts even at very low conversions.

While the invention has been described in its preferred embodiments, it is to be understood that the words which have been used are words of description rather than of limitation and that changes may be made within the purview of the appended claims without departing from the true scope and spirit of the invention in its broader aspects. Rather, various modifications may he made in the details within the scope and range of equivalents of the claims and without departing from the spirit of the invention. The inventors further require that the scope accorded their claims be in accordance with the broadest possible construction available under the law as it exists on the date of filing hereof (and of the application from which this application obtains priority,) and that no narrowing of the scope of the appended claims be allowed due to subsequent changes in the law, as such a narrowing would constitute an ex post facto adjudication, and a taking without due process or just compensation.

What is claimed is:

1. A method for preparing a titano-silicate molecular sieve, comprising the steps of:
a) reacting a silica source with an aqueous, alkaline solution of an organic structure directing agent under conditions sufficient to activate the silica source forming silica species in an activated silica solution, wherein the silica species are more reactive than the silica source;
b) combining the activated silica solution with a titanium source under conditions sufficient to form titanium-silicate oligomeric species in a titanium-silicate solution;
c) pretreating the titanium-silicate solution by aging the titanium-silicate solution under conditions sufficient to promote formation of nuclei or nuclear precursor species;
d) crystallizing the titanium-silicate solution under conditions sufficient to produce titanium-silicate crystals in a liquid phase;
e) separating the titanium-silicate crystals from the liquid phase;
f) washing the titanium-silicate crystals;
g) drying the titanium-silicate crystals after step f); and
h) calcining the titanium-silicate crystals to provide the titanium-silicate molecular sieve.

2. The method for preparing a titanium-silicate molecular sieve according to claim 1, wherein the silica source of step a) is selected from the group consisting of silica gel, precipitated silica, silica sol, fumed silica, and mixtures thereof.

3. The method for preparing a titanium-silicate molecular sieve according to claim 1, wherein the organic structure directing agent of step a) is a quaternary ammonium compound.

4. The method for preparing a titanium-silicate molecular sieve according to claim 3, wherein the quaternary ammonium compound is selected from the group consisting of at least one of tetrapropyl ammonium hydroxide (TPAOH) and tetrabutylammonium hydroxide (TBAOH).

5. The method for preparing a titanium-silicate molecular sieve according to claim 4, wherein the titanium-silicate solution of step c) has a mole ratio of tetraalkylammonium cation to silica (TPA⁺+TBA⁺):SiO₂ from about 0.1:1 to about 0.5:1.

6. The method for preparing a titanium-silicate molecular sieve according to claim 5, wherein the mole ratio of tetraalkylammonium cation to (TPA⁺+TBA⁺):SiO₂ is from about 0.2:1 to about 0.3:1.

7. The method for preparing a titanium-silicate molecular sieve according to claim 3, wherein the quaternary ammonium compound comprises a mixture of at least one of TPAOH and TBAOH with at least one of tetrapropylammonium halide and tetrabutylammonium halide.

8. The method for preparing a titanium-silicate molecular sieve according to claim 3, wherein the quaternary ammonium compound comprises a mixture of at least one of TPAOH and TBAOH with at least one of tetrapropylammonium halide and tetrabutylammonium halide in combination with a further tetraallylammonium hydroxide.

9. The method for preparing a titanium-silicate molecular sieve according to claim 8, wherein the further tetraalkylammonium hydroxide is tetraethylammonium hydroxide (TEAOH).

10. The method for preparing a titanium-silicate molecular sieve according to claim 1, wherein the titanium source of step b) is selected from the group consisting of a tetraalkyltitanate and a titanium complex.

11. The method for preparing a titanium-silicate molecular sieve according to claim 10, wherein the tetraalkyltitanate is selected from the group consisting of tetra-n-butyl titanate, tetraethyl titanate, tetraisopropyl titanate, and tetrakis(2-ethylhexyl) titanate.

12. The method for preparing a titanium-silicate molecular sieve according to claim 10, wherein the titanium complex is selected from the group consisting of acetylacetonate titanate, ethyl acetoacetate titanate, triethanolamine titanate, and lactic acid titanate.

13. The method for preparing a titanium-silicate molecular sieve according to claim 1, wherein the titanium source of step b) is selected from the group consisting of ammonium titanium hexafluoride, titanium fluoride, peroxytitanate, and hexafluorotitanic acid.

14. The method of preparing a titanium-silicate molecular sieve according to claim 1, wherein the titanium source of step b) is an amorphous titanium-silica.

15. The method for preparing a titanium-silicate molecular sieve according to claim 1, wherein the titanium source of step b) is added to achieve a mole ratio of TiO₂:SiO₂ from about 0.001 to about 0.07.

16. The method for preparing a titanium-silicate molecular sieve according to claim 15, wherein the mole ratio of TiO₂:SiO₂ is from about 0.01 to about 0.025.

17. The method for preparing a titanium-silicate molecular sieve according to claim 1, wherein the titanium-silicate solution of step c) has a mole ratio of H₂O:SiO₂ from about 3:1 to about 20:1.

18. The method for preparing a titanium-silicate molecular sieve according to claim 17, wherein the mole ratio of H₂O:SiO₂ is from about 5:1 to about 8:1.

19. The method for preparing a titanium-silicate molecular sieve according to claim 1, wherein the organic structure directing agent comprises a mixture of TPAOH+TBAOH and provides a first source of a base and the titanium-silicate solution of step c) has a mole ratio of OH⁻:SiO₂ from about 0.1 to about 0.5, wherein about 50 mole percent to about 100 mole percent of the base originates from the TPAOH+TBAOH and the remaining balance of the base is derived from a second source of the base.

20. The method for preparing a titanium-silicate molecular sieve according to claim 19, wherein the second source of the base is tetraethylammonium hydroxide.

21. The method for preparing a titanium-silicate molecular sieve according to claim 1, wherein step a) includes agitating the silica source and the alkaline solution at a temperature from about 25° C. to about 100° C. and a length of time from about 1 hour to about 24 hours.

22. The method for preparing a titanium-silicate molecular sieve according to claim 21, wherein the temperature is about 80° C. and the length of time is from about 3 hours to about 8 hours.

23. The method for preparing a titanium-silicate molecular sieve according to claim 1, further comprising cooling the activated silica solution, after step a), to about room temperature or lower.

24. The method for preparing a titanium-silicate molecular sieve according to claim 1, wherein step b) includes agitating the mixture of the activated silica solution and the titanium source at about room temperature or lower after addition of the titanium source to the activated silica solution for a time from about 0.5 hours to about 20 hours.

25. The method for preparing a titanium-silicate molecular sieve according to claim 1, wherein step c) includes agitating the titanium-silicate solution at a temperature from about 30° C. to about the boiling point and a length of time from about 1 hour to about 6 days.

26. The method for preparing a titanium-silicate molecular sieve according to claim 25, wherein the temperature is from about 50° C. to about 100° C. and the length of time is from about 12 hours to about 3 days.

27. The method for preparing a titanium-silicate molecular sieve according to claim 1, wherein the conditions of step d) include a temperature from about 80° C. to about 190° C. and a length of time from about 2 hours to about 7 days.

28. The method for preparing a titanium-silicate molecular sieve according to claim 1, wherein step d) is carried out at a temperature that is greater than the temperature at which step c) is carried out.

29. The method for preparing a titanium-silicate molecular sieve according to claim 1, wherein step e) comprises coagulating the silica dissolved in the liquid phase by adjusting the pH of product slurry in the liquid phase to a pH from about 2 to about 10, heating the pH adjusted slurry, and then filtering out slurry solids.

30. The method for preparing a titanium-silicate molecular sieve according to claim 1, wherein step e) comprises separating the Ti-silicate crystals from the liquid phase by flocculation of the crystals in the liquid phase with a flocculant.

31. The method for preparing a titanium-silicate molecular sieve according to claim 1, wherein step e) comprises separating the Ti-silicate crystals from the liquid phase by centrifuging.

32. A method for preparing a titanium-silicate molecular sieve, comprising the steps of.
a) combining a titania-silica co-gel with an aqueous, alkaline solution of an organic structure directing agent under conditions sufficient to form titanium-silicate oligomeric species in a titanium-silicate solution;
b) pretreating the titanium-silicate solution by aging the titanium-silicate solution under conditions sufficient to promote formation of nuclei or nuclear precursor species;
c) crystallizing the titanium-silicate solution under conditions sufficient to produce titanium-silicate crystals in a liquid phase;
d) separating the titanium-silicate crystals from the liquid phase;
e) washing the titanium-silicate crystals;
f) drying the titanium-silicate crystals after step e); and
g) calcining the titanium-silicate crystals to provide the titanium-silicate molecular sieve.

33. The method for preparing a titanium-silicate molecular sieve according to claim 32, wherein the titania-silica cogel has a mole ratio of TiO₂:SiO₂ from about 0.00 1 to about 0.07.

34. A method for preparing a titanium-silicate molecular sieve, comprising the steps of:
a) combining a reactive silica source, a titanium source, and a Ti-complexing agent under conditions sufficient to form titanium-silicate oligomeric species in a titanium-silicate solution;
b) pretreating the titanium-silicate solution by aging the titanium-silicate solution under conditions sufficient to promote formation of nuclei or nuclear precursor species;
c) crystallizing the titanium-silicate solution under conditions sufficient to produce titanium-silicate crystals in a liquid phase;
d) separating the titanium-silicate crystals from the liquid phase;
e) washing the titanium-silicate crystals;
f) drying the titanium-silicate crystals after step e); and
g) calcining the titanium-silicate crystals to provide the titanium-silicate molecular sieve.

35. The method for preparing a titanium-silicate molecular sieve according to claim 34, wherein the reactive silica source of step a) is a tetraalkylorthosilicate.

36. The method for preparing a titanium-silicate molecular sieve according to claim 34, wherein the tetraalkylorthosilicate is tetraethylorthosilicate.

37. The method for preparing a titanium-silicate molecular sieve according to claim 34, wherein the reactive silica source of step a) is provided by a silica source selected from the group consisting of precipitated silica, silica gel, silica sol, and fumed silica, being activated by reacting the silica source with an aqueous, alkaline solution of an organic structure directing agent.

38. The method for preparing a titanium-silicate molecular sieve according to claim 34, wherein the Ti-complexing agent of step a) is an amine source.

39. The method for preparing a titanium-silicate molecular sieve according claim 38, wherein the amine source is selected from the group of consisting of hexamethylenediamine (HMD), ethylenediamine (EDA), n-butylamine, diethylamine, diethanolamine, and triethanolamine.

40. The method for preparing a titanium-silicate molecular sieve according to claim 39, wherein the amine source is selected from the group consisting of hexamethylenediamine (HMD) and ethylenediamine (EDA).

41. The method for preparing a titanium-silicate molecular sieve according to claim 40, wherein the HMD or EDA mole ratio to SiO₂ is from about 0.1:1 to about 1:1.

42. The method for preparing a titanium-silicate molecular sieve according to claim 34, wherein step d) comprises separating the Ti-silicate crystals from the liquid phase by flocculation of the crystals in the liquid phase with a flocculant or by centrifuging.

43. A method for preparing a titanium-silicate molecular sieve, comprising the steps of,
a) combining a reactive silica source and a titanium source under conditions sufficient to form titanium-silicate oligomeric species in a titanium-silicate solution;
b) pretreating the titanium-silicate solution by aging the titanium-silicate solution under conditions sufficient to promote formation of nuclei or nuclear precursor species;
c) crystallizing the titanium-silicate solution under conditions sufficient to produce titanium-silicate crystals in a liquid phase;
d) separating the titanium-silicate crystals from the liquid phase;
e) washing the titanium-silicate crystals with an acidic wash solution;
f) drying the titanium-silicate crystals after step e); and
g) calcining the titanium-silicate crystals to provide the titanium-silicate molecular sieve.

44. The method for preparing a titanium-silicate molecular sieve according to claim 43, wherein the acidic wash solution is acidified deionized water.

45. The method for preparing a titanium-silicate molecular sieve according to claim 43, wherein the acidic wash solution is from about 0.05 weight percent to about 10 weight percent nitric acid, hydrochloric acid, or sulfuric acid.

46. The method for preparing a titanium-silicate molecular sieve according to claim 43, wherein step e) comprises first washing the titanium-silicate crystals with an aqueous acidic solution and then washing the titanium-silicate crystals with deionized water.

47. The method for preparing a titanium-silicate molecular sieve according to claim 43, wherein step d) comprises coagulating the silica dissolved in the liquid phase by adjusting the pH of product slurry in the liquid phase to a pH from about 2 to about 10, heating the pH adjusted slurry, and then filtering out slurry solids.

48. The method for preparing a titanium-silicate molecular sieve according to claim 43, wherein step d) comprises separating the Ti-silicate crystals from the liquid phase by flocculation of the crystals in the liquid phase with a flocculant or by centrifuging.

49. The method for preparing a titanium-silicate molecular sieve according to claim 43, wherein after step e) a titanium-silicate molecular sieve is treated by strong (1-6N) mineral acid at 50-100 C. for 0.5-2 hours, then washed with deionized water, separarated by filtration and calcined.

50. The method for preparing a titanium-silicate molecular sieve according to claim 43, wherein the reactive silica source of step a) is a tetraalkylorthosilicate.

51. The method for preparing a titanium-silicate molecular sieve according to claim 49, wherein the tetraalkylorthosilicate is tetraethylorthosilicate.

52. The method for preparing a titanium-silicate molecular sieve according to claim 43, wherein the reactive silica source of step a) is provided by a silica source selected from the group consisting of precipitated silica, silica gel, silica sol, and famed silica, being activated by reacting the silica source with an aqueous, alkaline solution of an organic structure directing agent.

53. The method for preparing a titanium-silicate molecular sieve according to claim 43, wherein the Ti-complexing agent of step a) is an amine source.

54. The method for preparing a titanium-silicate molecular sieve according claim 53, wherein the amine source is selected from the group of consisting of hexamethylenediamine (HMD), ethylenediamine (EDA), n-butylamine, diethylamine, diethanolamine, and triethanolamine.

55. The method for preparing a titanium-silicate molecular sieve according to claim 54, wherein the amine source is selected from the group consisting of hexamethylenediamine (HMD) and ethylenediamine (EDA).

56. The method for preparing a titanium-silicate molecular sieve according to claim 55, wherein the HMD or EDA mole ratio to SiO₂ is from about 0.1:1 to about 1:1.

57. A method for preparing a titanium-silicate molecular sieve, comprising the steps of,
h) combining a reactive silica source and a titanium source under conditions sufficient to form titanium-silicate oligomeric species in a titanium-silicate solution;
i) pretreating the titanium-silicate solution by aging the titanium-silicate solution under conditions sufficient to promote formation of nuclei or nuclear precursor species;
j) crystallizing the titanium-silicate solution under conditions sufficient to produce titanium-silicate crystals in a liquid phase;
k) separating the titanium-silicate crystals from the liquid phase;
l) steaming the titanium-silicate crystals;
m) drying the titanium-silicate crystals after step e); and
n) calcining the titanium-silicate crystals to provide the titanium-silicate molecular sieve.

58. A method of oxyfunctionalizing an organic material comprising the steps of,
a) contacting the organic material with an oxidizer selected from the group of molecular oxygen, aqueous H₂O₂, peroxides, and alkylhydroperoxides, in contact with TS-PQ titano-silicate molecular sieve, characterized by predominance of 220 nm bant on its UV-VIS DR spectra, at temperatures from about 40° C. to about 60° C., for a period of time sufficient to convert a substantial amount of the organic material into an oxyfunctionalized organic material; and
b) recovering the oxyfunctionalized organic material as a product.

59. The method of claim 58 wherein step a) further comprises the reduction of the pH of the organic material, oxidizer, and TS-PQ titano-silicate molecular sieve system by the addition of an acid.

60. The method of claim 58 wherein step a) is carried out in the absence of solvents.

61. The method of claim 58 wherein step a) is carried out in the presence of solvents.

62. The method of claim 58 wherein the oxyfunctionalization is carried out with less than about 5% loss of oxidizer during the process, when the contact time between the catalyst and oxidizer is less than about 1 hour.

63. The method of claim 58 wherein the oxyfunctionalization is carried out with less than about 5% loss of oxidizer during the process, when the contact time between the catalyst and oxidizer is less than about 30 minutes.

63. The method of claim 58 wherein the oxyfunctionalization is carried out with less than about 5% loss of oxidizer during the process, when the contact time between the catalyst and oxidizer is less than about 1 minute.

64. The method of claim 58, where the organic material is selected from the group of alkanes, alkenes, arenes, alcohols, carbonyls, and sulfides.

65. The method of claim 58 wherein the paraffinic material is n-hexane, and the oxyfunctionalized paraffinic materials are hexanols and hexanones.

66. A titano-silicate molecular sieve characterized by strong band on UV-VIS DRV spectra at 200-210 nm and/or at 215-300 nm area with absence or less intensive band in 240-300 nm area and above 300 nm.

67. The titano-silicate molecular sieve of claim 66 characterized by a strong UV-VIS DRV absorbtion band at about 220 nm that has an intensity equal to or larger than any absorbtion band below about 210 nm.

68. The titano-silicate molecular sieve of claim 66 further characterized by absorption bands near ˜210 nm and in the 250-400 nm region, which have intensities weaker than the band at about 45,000 cm⁻¹.
